(19) United States
(12) Patent Application Publication
(10) Pub. No.: US 2017/0210531 A1
(43) Pub. Date: Jul. 27, 2017

(54) IMPROVEMENTS IN CHILD-RESISTANT PACKAGES

(71) Applicant: Duff Design Limited, London (GB)

(72) Inventors: Alexander Parker, London (GB); Burgo Wharton, London (GB)

(73) Assignee: Duff Design Limited, London (GB)

(21) Appl. No.: 15/329,001

(22) PCT Filed: Jul. 27, 2014
(86) PCT No.: PCT/GB2015/052166

§ 371 Date: Jan. 25, 2017

(30) Foreign Application Priority Data
Jul. 25, 2014 (GB) 1413263.3

(51) Int. Cl. B65D 75/52; A61J 1/03; B65D 75/36

(52) U.S. Cl. CPC B65D 75/52; B65D 75/367; A61J 1/035

(57) ABSTRACT

A tab member for use in a latchable slidable package. The tab member has opposed major faces connected by opposed side edges and comprises a body portion and a cut out defining a resiliently deformable latch member connected to the body portion by at least one live hinge. The latch member incorporates a latch formation that is moveable by a user in an unlatching direction substantially orthogonal to at least one side edge. The tab member is substantially planar, and the unlatching direction lies substantially in a plane of the tab member. The tab member can be incorporated into a latchable slidable package to provide child resistance by virtue of the latch member and the latch formation. The substantially planar nature of the tab member means that the tab member can be easily accommodated in the package. Because the unlatching direction of the latch formation lies substantially in a plane of the tab member, the movement of the latch formation as the package is unlatched is substantially restricted to the same plane. Thus, the volume of the package that must be given to accommodate the tab member and the movement of the latch formations can be kept low, thereby reducing the overall size and weight of the package.

This invention relates to packaging such as a box, which may be used in the packaging of items. In particular, though not exclusively, the invention relates to a child-resistant package for storing potentially hazardous materials such as, for example, pharmaceuticals arranged in a blister-pack, which must be kept safe from children or irresponsible adults.

The safe storage of potentially hazardous materials such as pharmaceuticals has long been a problem for families with young children. Whilst parents desire access to a wide range of pharmaceuticals in order to be able to treat illnesses promptly and easily, the natural curiosity of children can cause them to seek out and ingest such materials when unsupervised. This can have serious consequences. For example, an overdose of virtually any pharmaceutical is injurious to health. Indeed some pharmaceuticals are entirely unsuitable for children and have an adverse effect on the health of children even if handled or ingested in very small quantities.

For the sake of simplicity, potentially hazardous materials such as those described above will hereinafter simply be referred to as “hazardous materials”. Additionally, the problems described above are not limited to children and can also arise in respect of irresponsible or forgetful adults, such as for example some mentally ill or mentally disabled patients, or the elderly who may be prone to confusion as to the contents of a package. Whilst the focus of this specification is on children, it will be appreciated that the majority of what is described herein applies analogously to irresponsible or forgetful adults. All such analogies are within the scope of this specification, even where reference is made only to children.

In light of their dangerous nature, hazardous materials must be kept out of the reach of children. This is an established practice that is of fundamental importance and which may be augmented, but can never be replaced, by child resistant closures (CRCs). CRCs make it harder for children to extract hazardous materials from a package, if they do manage gain access to them in packaged form.

Many CRC designs have been suggested in the past. However, such CRC designs are often complicated in structure and expensive to manufacture. Since the cost of packaging is generally passed on to consumers, this leads consumers to buy products in non-resistant packaging where available, thereby increasing the risk of accidental poisonings and the like. Minimising complexity of a CRC design and its manufacturing process, and hence minimising its cost, is therefore crucial in providing a successful CRC.

A further design consideration is that once a CRC has been opened, it is important that it can be easily and perceptibly returned to a secured position. If the mechanism for returning the CRC to a secured position is too complicated, the user may omit to return the CRC to the secured position, thereby leaving the hazardous material more easily accessible. If it is not obvious to the user that the CRC has been returned to the secured position, the user may inadvertently fail to secure the package correctly before it is returned to its storage place, negating the child-resistant design.

It is an object of this invention to address at least one of the problems described above.

### STATEMENTS OF THE INVENTION

Against this background, the invention resides in a tab member for use in a latchable slidable package. The tab member has opposed major faces connected by opposed side edges and comprises a body portion and a cut-out defining a resiliently deformable latch member connected to the body portion by at least one live hinge. The latch member incorporates a latch formation that is moveable by a user in an unlatching direction substantially orthogonal to at least one side edge. The tab member is substantially planar, and the unlatching direction lies substantially in a plane of the tab member.

The tab member of the invention can be incorporated into a latchable slidable package to provide child resistance by virtue of the latch member and the latch formation. When the latch formation is engaged, the tab member cannot be removed from the package. A user can unlatch the tab member by moving the latch formation in the unlatching direction, thereby allowing the tab member to be removed from the package and permitting access to the contents of the package.

The substantially planar nature of the tab member means that the tab member can be easily accommodated in a package. Because the unlatching direction of the latch formation lies substantially in a plane of the tab member, the movement of the latch formation as the latch formation is unlatched is substantially restricted to the plane of the tab member. This is further facilitated by the cut outs that define the latch member: as the latch formation moves in the unlatching direction, the displaced latch formation is accommodated in the space of the cut out, thereby allowing movement of the latch formation to remain substantially in the plain of the tab member.

In this way, movement of the latch formation can also be easily accommodated inside the package. As a result of the planar nature of the tab member and the unlatching direction being substantially in the plane of the tab member, the volume of the package that must be given to accommodate the tab member and the movement of the latch formations can be kept low, thereby reducing the overall size and weight of the package.

The latch member may incorporate at least an edge portion of the side edge of the tab member. The latch formation may comprise a locking formation of the edge portion. When the tab member is integrated into a package, and the latch member is in an engaged state, the locking formation may abut a corresponding abutment edge on the package to prevent movement of the tab member.

The locking formation may lie at an acute angle to an adjacent portion of the side edge. This arrangement is particularly advantageous because if a user attempts to force the tab member to move out of the package when the latch formations are in an engaged state, the acute angle of the locking formation will tend to force the latch formations in a direction opposite to the unlatching direction and hence further into the engaged state.

The latch formation may comprise a ramp formation opposed to the locking formation that lies at an obtuse angle to an adjacent portion of the side edge. As the tab member is pushed back inside a package, the ramp come into contact with side walls of the package. The obtuse angle of the ramp guides movement of the latch formations in the unlatching direction such that the latch formation does not catch on the other components of the package, thereby allowing the latch formation to slide back inside the package once again.

The latch member may be disposed between the cut-out and the side edge. The cut-out may be an elongate slot substantially aligned with and arranged near the side edge. A long slot allows for particularly high flexibility of the latch member.

The latch member may be connected to the body portion by a pair of live hinges arranged at opposed ends of the latch member. Using a pair of live hinges at opposite ends fixes the latch member particularly securely to the body of the tab member, thereby reducing the chance of the latch member breaking away from the body, particularly when the tab member is not integrated into a package or is otherwise exposed.

The latch formation may be integral with the latch member. Alternatively, the latch formation may be a separate piece that is attached to the latch member. The latch member may be integral with the body portion. Alternatively, the latch member may be a separate piece that is attached to the body portion via one or more live hinges.

To augment the child resistance provided by the tab member when integrated into a slidable latchable package, a second latch member may be provided on an opposed second side edge of the tab member.

The tab member may be a cut or stamped sheet. Alternatively, the tab member may be made by another suitable means, such as by injection moulding. Stamping, cutting and injection moulding are advantageous production methods as they are simple and inexpensive.

To minimise the thickness of the tab member, in cross section substantially orthogonal to the side edge, the body and the latch member may be of substantially the same thickness.

The tab member may have a length-to-thickness ratio of at least 20:1. More particularly, the tab member may have a length-to-thickness ratio of at least 100:1.

The tab member may further comprise an information sheet or booklet attached to the tab member. The information sheet may contain, for example, information regarding hazardous materials that are to be stored in a package into which the tab member is to be integrated.

The tab member may further comprise a retainer for retaining the sheet or booklet in a closed position. The retainer may be an adhesive label that is attachable to the sheet or booklet, and removably attachable to the tab member. The retainer assists in secure storage of the information booklet, and, when the tab member is integrated into the package, helps to prevent the information booklet catching on other components of the package.

The tab member may incorporate a blister-pack. For example, the blister pack may form the body of the tab member, and cut outs may be provided in the blister pack to define the latch member. In other embodiments, the latch member and the live hinge may be provided as a separate piece that is attached to a blister pack to form the tab member.

The tab member may comprise at least one ridge that protrudes out of the plane of the tab member. Such a ridge acts to define a minimum overall thickness of the tab member so that the tab member may fit snugly into a sleeve when incorporated into a package. The ridge may be provided on the body portion of the tab member.

The ridge may be elongate and may lie substantially parallel to a side edge of the tab member. To maximise a continuous area of the tab member that is free from ridges and/or cut-outs, the ridge may lie adjacent to a cut-out. This maximises the continuous area available for receiving printed information or an information booklet.

The tab member may comprise a pair of ridges, each ridge lying adjacent to a respective cut out. In this case, if an information booklet is provided, the booklet may be provided between the ridges.

The tab member may be provided with an adhesive assist feature for assisting adhesion of a booklet to the tab member.

The invention also extends to a latchable package comprising: a support for supporting one or more items; a structure for selectively blocking access to the or each item; and any tab member according to the invention described above. The tab member is coupled to the support such that movement of the tab member with respect to the structure in a driving direction effects movement of the support in an access direction different to the driving direction, such that the support is moveable between a secured position in which access to the item is blocked by the structure and an access position in which the item is accessibly clear of the structure. At least one side edge of the tab member is substantially aligned with the driving direction and the latch formation is moveable by a user in an unlatching direction substantially orthogonal to the side edge between an engaged state in which the tab member is prevented from moving in the driving direction and a disengaged state in which the tab member is allowed to move in the driving direction.

The structure may comprise an abutment edge, and a locking formation of the tab member may bear against the abutment edge to prevent the tab member from moving in the driving direction. The abutment edge and locking formation provide a particularly simple means for preventing movement of the tab member when the latches are in an engaged state.

The structure may comprise an aperture that receives the latch formation when the package is in the secured position and the latch formation is in the engaged state, and the aperture may define the abutment edge of the structure. The aperture additionally accommodates the latch formation when it is in an engaged state, and provides the user with finger access to the latch formation to move it to the disengaged state when required.

To minimise the thickness of the overall package further, a thickness of the tab member may be less than a thickness of the support. In particular, the ratio of the thickness of the support to the thickness of the tab member may be at least 5:1. More particularly, the ratio of the thickness of the support to the thickness of the tab member may be at least 10:1.

The structure may comprise a first passage that houses the support and a second passage that houses the tab member, the tab member being arranged in the second passage with a close sliding fit. The second passage may comprise at least one wall that lies in a plane parallel to the plane of the tab member, the wall restraining movement of the latch member in the plane of the tab member.

The wall may restrain deformation of the tab member out of the plane of the tab member. In this way, if the tab member becomes deformed in the course of use, or is not of self-supporting stiffness, the restraining effect of the wall can counteract the deformation out of the plane of the tab member, to ensure that the latches can still be arranged in the engaged state, and can still be moved in the unlatching direction.

To reinforce the restraining effect, the second passage may comprise opposed walls that lie respectively in planes parallel to the plane of the tab member.

The support may comprise a blister pack. In this case, the blister pack may comprise a front end that is driven out of the package in the driving direction upon movement of the tab member and a rear end opposite the front end, and the blister pack may comprise one or more empty blisters at a rear end of the blister pack and one or more empty blisters at a front end of the blister pack. The empty front and rear blisters act to define a fixed thickness of the support, such that the support fits snugly into the lower passage of the package.

The empty front and rear blisters may be of substantially the same depth. In this way, when the blister pack is laid on a flat surface, or is stacked on top of other blister packs, the blister pack will lie horizontally. This horizontal configuration allows particularly stable stacking of blister packs and also facilitates machine-feeding of blister packs in a stack.

The blister pack may comprise one or more ridges that extend substantially parallel to the driving direction and/or one or more ridges that extend transverse to the driving direction. The ridges increase the stiffness of the blister back and resist bending or torsion of the pack which contributes further to the child-resistance of the pack.

For ease of manufacture, the or each ridge may be a channel formed by an elongate blister.

The invention extends further to a sleeve blank for use in a child-resistant slidable package comprising: a plurality of integral sections demarcated by creases or scores, the sections comprising at least a minor side wall and a neighbouring major wall; and at least one aperture straddling a crease or score between the side wall and the major wall, such that the aperture extends into the first side wall and into the major wall. The aperture is defined by one or more edges, at least one edge being disposed on the side wall and being non-linear so as to facilitate thumb or finger access to the aperture when the sleeve is folded.

The non-linear wall of the aperture acts to enlarge the aperture in particular places, which facilitates thumb or finger access to the aperture. When the sleeve is incorporated into a package, this facilitates access to the latch formations. In this way, access to the latch formations can be easily achieved without the need to enlarge the entire aperture. This is particularly advantageous because if the aperture is made to large it may provide an access route for children, allowing them to access hazardous material inside the package.

The wall of the aperture may be, for example, curved downwardly, or it may be shaped as a ‘V’ or ‘U’ shape.

The invention extends still further to a method of making a slidable package, the method comprising; arranging a band around a divider section of a sleeve blank; bonding a support for packaged items to the band; bonding a tab member according to the invention to the band; and folding the sleeve blank around the support and the tab member to assemble the band-driven package.

The sleeve blank may be the sleeve blank of the invention as described above.

From another aspect, the invention also resides in a package comprising: a support for supporting one or more items; a structure for selectively blocking access to the or each item; and a tab member that at least partially overlies or underlies the support. The tab member is coupled to the support such that movement of the tab member with respect to the structure in a driving direction effects movement of the support in an access direction different to the driving direction, such that the support is moveable between a closed position in which access to the item is blocked by the structure and an open position in which the item is accessibly clear of the structure. The support and the tab member comprise respective gripping formations suitable to be gripped by a user, the gripping formations being arranged such that at least a portion of the gripping formation of the tab member does not overlie or underlie the support, and at least a portion of the gripping formation of the support does not overlie or underlie the tab member. The structure is configured to permit finger access to each gripping formation.

From this aspect, the invention enables a user easily to access a gripping formation on either the tab or the support of the package. By avoiding overlap between at least a portion of the gripping formations, a user can easily grip one or the other of the gripping formations.

The structure may comprise at least one cut-out arranged to provide finger access to the gripping formations. For example, the structure may comprise a first cut-out arranged to provide finger access to the gripping formation of the tab member and a second cut-out arranged to provide access to the gripping formation of the support.

Additionally or alternatively, the gripping formations may protrude from the structure.

The gripping formations may be tabs. Tabs are a simple formation that can be easily manufactured, either integrated with the tab member or support, or as a separate piece to be attached to the tab member or support.

The gripping formations may be arranged at the same end of the package. Alternatively, the gripping formations may be arranged at different ends of the package.

The tab member may be a support for supporting one or more items. For example, the tab member may incorporate a blister pack.

The tab member may be a tab member according to the invention as described above.

It will be appreciated that preferred and/or optional features of each of the various aspects of the invention may be incorporated alone or in appropriate combination in other aspects of the invention also.

### BRIEF DESCRIPTION OF THE FIGURES

In order that the invention may be more readily understood, reference will now be made, by way of example, to the accompanying drawings, in which:

FIG. 1 is a perspective view of a package of the invention in a fully-closed state;

FIG. 2 is a perspective view of the package of FIG. 1 in a fully-open state;

FIG. 3 is a perspective view of a blister-pack for use in the package of FIGS. 1 and 2;

FIG. 4 is a perspective view of a tab member for use in the package of FIG. 1;

FIG. 5 is a partial enlarged view of a latch formation of the tab member of FIG. 4, when arranged in the package of FIG. 1;

FIG. 6 is a plan view of an alternative embodiment of a tab member for use in the package of FIGS. 1 and 2;

FIG. 7 is a plan view of a sleeve blank according to the invention for use in the package of FIG. 1;

FIGS. 8 to 13 illustrate a method of assembling a package according to FIGS. 1 and 2;

FIGS. 14a and 14b are schematic plan views of the tab member of FIG. 4 arranged in the package of FIG. 1, with the latch formations in an engaged state;

FIGS. 15 and 16 are schematic plan views of the tab member of FIG. 4 arranged in the package of FIG. 1, with the latch formations in a disengaged state;

FIG. 17 is a perspective view of another package of the invention in a fully-closed state;

FIGS. 18A and 18B are perspective views of the package of FIG. 17 in alternative fully-open states;

FIG. 19 is a perspective view of a tab member for use in the package of FIG. 17;

FIG. 20 is a partial enlarged view of a latch formation of the tab member of FIG. 19, when arranged in the package of FIG. 17;

FIGS. 21A and 21B are schematic plan views of the tab member of FIG. 19 arranged in the package of FIG. 17, with the latch formations in an engaged state and a disengaged state respectively;

FIGS. 22A and 22B are schematic plan views of the tab member of FIG. 19 arranged in the package of FIG. 17, with the tab member moved in directions X and Y respectively;

FIG. 23 is a perspective view of another package of the invention in a fully-closed state;

FIGS. 24A and 24B are perspective views of the package of FIG. 23 in alternative fully-open states;

FIG. 25 is a perspective view of a tab member for use in the package of FIG. 23;

FIG. 26 is a perspective view of a blister-pack for use in the package of FIG. 23;

FIGS. 27A and 27B are schematic plan views of the tab member of FIG. 25 and the blister-pack of FIG. 26 arranged in the package of FIG. 23, with the latch formations in an engaged state and a disengaged state respectively;

FIGS. 28A and 28B are schematic plan views of the tab member of FIG. 25 and the blister-pack of FIG. 26 arranged in the package of FIG. 23, with, respectively, the tab member and the blister pack moved in direction X;

FIG. 29 is a perspective view of another package of the invention in a fully-closed state;

FIGS. 30A and 30B are perspective views of the package of FIG. 29 in alternative fully-open states;

FIGS. 31A, and 31B, are perspective and plan views respectively of a another tab member for use in a package, FIG. 31C is a cross-sectional view of the tab member of FIGS. 31A and 31B along the line A-A of FIG. 31B without a booklet, and FIG. 31D is a cross-sectional view of the tab member of FIGS. 31A and 31B along the line A-A of FIG. 31B with a booklet.

FIGS. 32A and 32B are plan and side views respectively of another blister-pack for use in a package;

FIGS. 33A and 33B are plan and side views respectively of another blister-pack for use in a package; and FIG. 34 is a plan view of another sleeve blank for use in a package.

### DETAILED DESCRIPTION OF EMBODIMENTS OF THE INVENTION

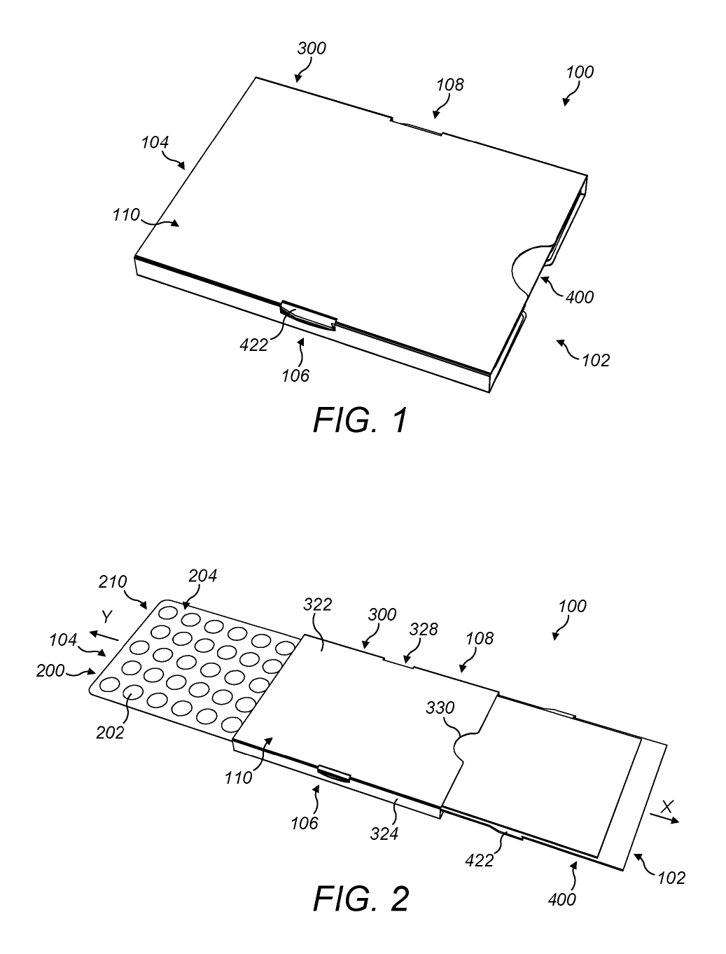

Referring to FIGS. 1 and 2, a child resistant package 100 comprises a support in the form of a blister-pack 200 for storing hazardous materials (not shown), a structure, in the form of a sleeve 300 for blocking access to the hazardous materials, and a tab member 400 for actuating the blister-pack 200. The package 100 comprises a rear end 102, a front end 104, a left side 106, a right side 108, an upper side 110, and a lower side (not shown).

The package 100 is moveable by a user between a fully-closed or secured position, shown in FIG. 1, in which access to the hazardous materials is blocked by the sleeve 300, and a fully-open or access position, shown in FIG. 2, in which access to the hazardous materials is permitted.

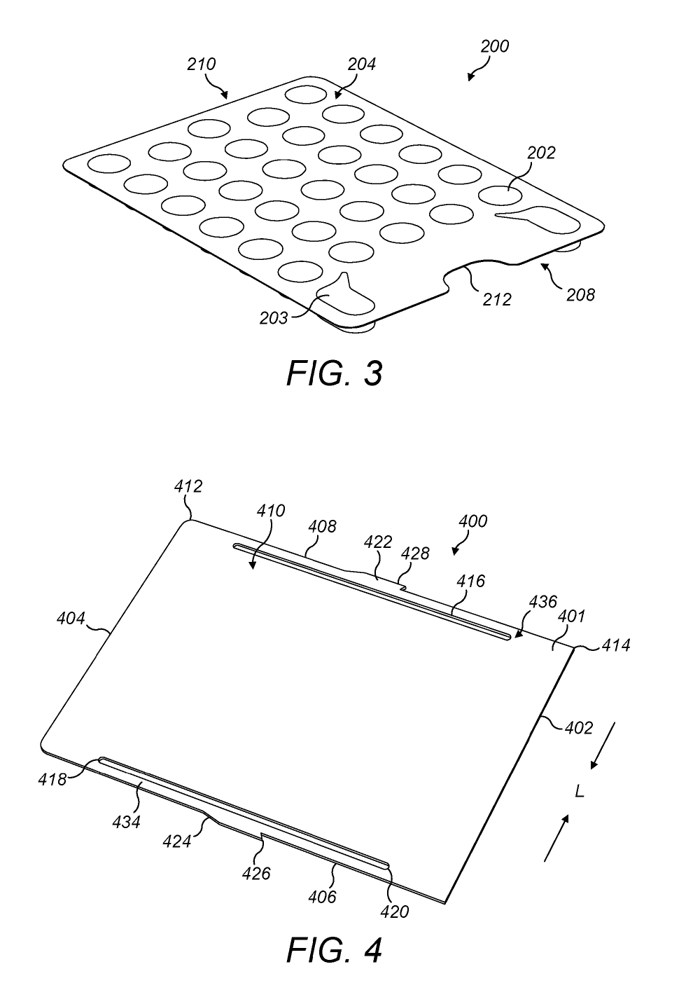

The blister-pack 200, best seen in FIGS. 2 and 3, provides storage for hazardous materials within a plurality of blisters 202 in conventional fashion and comprises an upper, foil-covered side 204, a lower blistered side (not shown in FIGS. 2 and 3, but visible in FIG. 9), a rear end 208 and a front end 210. The content of a blister 202 may be accessed in conventional fashion by pressing it upwards to rupture the foil covering of the upper side 204 of the blister-pack 200.

The blister-pack 200 is substantially of a form as described in the Applicant's European Patent No. EP2154078. The rear end 208 of the blister-pack 200 comprises vacant blisters 203 or other supporting formations, which provide support to the blister-pack 200, to prevent it from drooping when it is arranged in the package 100 and in an open position. Between the vacant blisters 203, the blister-pack 200 comprises a curved indentation 212 in the form of a cut-out, which facilitates finger access to the tab member 400 when the package 100 is in the fully-closed position.

In the assembled package 100, the blister-pack 200 is housed within the sleeve 300, along with the tab member 400. The blister-pack 200 is coupled to the tab member 400, such that movement of the tab member 400 drives movement of the blister-pack 200, as will be described, and as is also described in detail in the Applicant's European Patent No. EP1140639.

Referring now to FIGS. 4 to 6, the tab member 400 is a panel or substrate formed from a substantially flat sheet, which is made from a flexible cardboard or plastics material. The tab member 400 is planar such that it extends in a plane parallel to the upper side of the blister-pack when it is housed in the package 100. The panel or substrate may be, for example, a cut or stamped sheet, or it may be an injection moulded sheet.

A body 401 forms the majority of the tab member 400. Cut-outs 416 in the body 401 define latch members 434, which are joined to the body 401 by live hinges 436.

The tab member 400 comprises a rear edge 402, a front edge 404, a left edge 406, a right edge 408, an upper side 410, and a lower side (not shown). At the front edge 404 of the tab member 400, corners 412 of the tab member 400 are radiused, for example with a radius of approximately 3 mm, while at the rear edge 402 of the tab member 400, corners 414 of the tab member 400 are formed substantially as right angles.

The distance between the front and rear edges 404, 402 defines a length of the tab member 400, and the distance between the left and right edges 406, 408 defines its width. The spacing between the upper side 410, and the lower side defines a thickness of the tab member 400, which is substantially less than its length or width.

In the embodiment illustrated, the sheet is a styrene sheet having a thickness of approximately 1 mm and a length of approximately 12 cm. The sheet therefore has a length-to-thickness ratio of approximately 120:1. The sheet is of a stiffness that is great enough to impart self-supporting stiffness to the sheet (i.e. the sheet is not significantly deformed under its own weight), but low enough to allow the sheet to flex to some degree. The sheet also has a yield stress that is high enough to allow substantial flexing of the sheet without plastic deformation.

The cut-outs 416 in the body 401 that define the latch members 434 take the form of left and right slots aligned respectively with left and right edges 406, 408 of the tab member 400. The slots 416 are elongate, being substantially oblong in shape, and extend parallel to the left and right edges 406, 408 along the majority of the length of those edges 406, 408.

The length of each slot 416 is substantially greater than the width of each slot. In the embodiment illustrated, the width of each slot 416 is approximately 2 mm, or twice the thickness of the tab member 400, and the length of each slot 416 is approximately 8 cm, or approximately forty times its width.

The elongate slots 416 terminate at front and rear ends 418, 420, which are spaced a distance from the respective front and rear edges 404, 402 of the tab member 400. In the embodiment illustrated, the elongate slots 416 have a length that is approximately 70% of the length of the tab member 400, and are arranged centrally with respect to the front and rear edges 404, 402 of the tab member 400.

In this way, the spacing between the front end 418 of the slot 416 and the front edge 404 of the tab member 400 is equal to the spacing between the rear end 420 of the slot 416 and the rear edge 402 of the tab member 400. This spacing is equal to approximately 15% of the length of the tab member 400.

As best seen in FIG. 4, at the left and right edges 406, 408 of the tab member 400, each latch member 434 is provided with a latch formation 422. Each latch formation 422 is disposed at a substantially central position on the respective left or right edge 406, 408 of the tab member 400, and protrudes outwardly from that edge 406, 408.

The tab member 400 is symmetrical about its central longitudinal axis. Therefore, the left and right latch formations 422 are mirror images of each other and function identically but in opposite directions. It will be appreciated that the latch formations 422 are spaced apart from one another by a distance that corresponds approximately to the width of the tab member 400. In the embodiment shown, this distance is sufficiently large that an adult, having relatively large hands, could depress both latch formations 422 simultaneously using only one hand, for example between thumb and forefinger, but a child, having relatively small hands, could not.

Considering for convenience the right edge 408 and right latch member 434 and latch formation 422 only, the latch member 434 is formed from the sheet, and hence is formed integrally with the body 401 of the tab member 400. Thus, the latch member 434 is of substantially the same thickness as the body 401 of the tab member 400, and lies in the same plane.

The latch member 434 is an elongate beam or arm that lies outboard of the slot 416 and encompasses a portion of the right edge 408 of the tab member 400. More specifically, the latch member 434 encompasses at least the portion of the right edge 408 of the tab member 400 that includes the latch formation 422. The latch member 434 terminates forwardly and rearwardly in live hinges 436 that are disposed longitudinally outboard of the respective front and rear ends 418, 420 of the slot 416.

The spacing between the slot 416 and the right edge 408 of the tab member 400 defines the width of the latch member 434. In the embodiment illustrated, the width of the latch member 434 is approximately 2.5 mm, which is slightly greater than the width of the slot 416. Consequently, the width of the latch member 434 is large enough that the latch member 434 is not easily broken and can provide structural support to the latch formation 422, but small enough that the latch member 434 can be deformed easily.

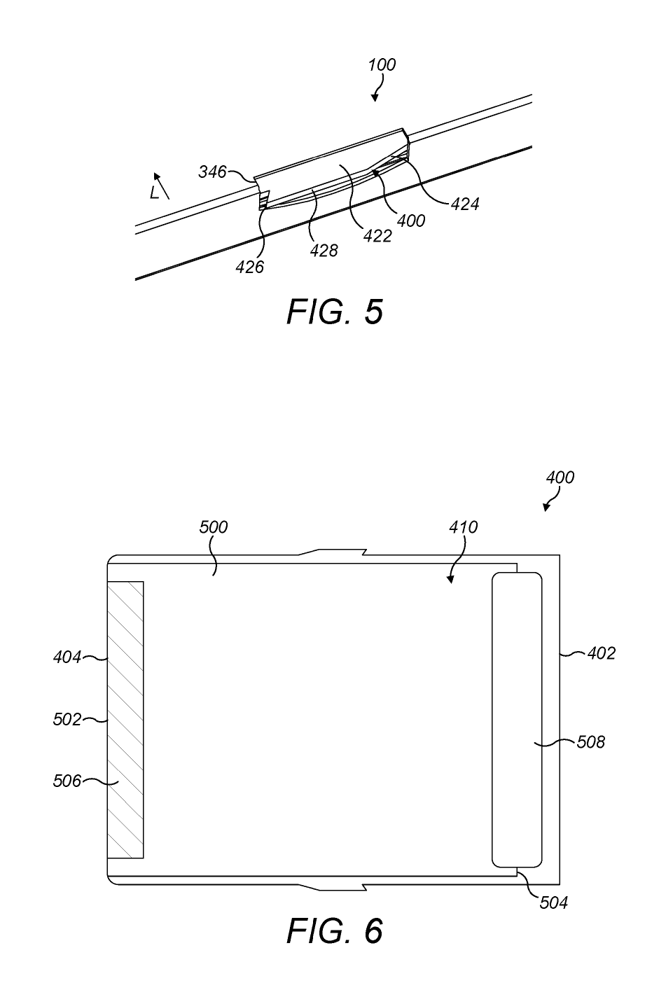

Referring to FIGS. 4 and 5, the latch formation 422 comprises a front edge 424, a rear edge 426, and an outer edge 428. The outer edge 428 of the latch formation 422 lies substantially parallel to the right side 408 of the tab member 400. The perpendicular spacing between the outer edge 428 of the latch formation 422 and the right edge 408 of the tab member 400 defines a width of the latch formation 422. The latch formation 422 is of a relatively small width compared to the width of the tab member 400: specifically, in the embodiment illustrated, the width of the latch formation 422 is approximately 1.5 mm, and is hence approximately 1.5 times the thickness of the tab member 400.

The front edge 424 of the latch formation 422 extends forwardly between the outer edge 428 of the latch formation 422 and the right edge 408 of the tab member 400. The front edge 424 is tapered so as to extend simultaneously inwardly, towards a centre of the tab member 400, and forwardly, towards the front edge 404 of the tab member 400, such that the front edge 424 meets both the outer edge 428 of the latch formation 422 and the right edge 408 of the tab member 400 at an obtuse angle of approximately 165°. Thus inclined, the front edge 424 of the latch formation 422 defines a ramp.

The rear edge 426 of the latch formation 422 also extends forwardly between the outer edge 428 of the latch formation 422 and the right edge 408 of the tab member 400. The rear edge 426 is inclined so as to extend simultaneously inwardly and forwardly, such that it meets both the outer edge 428 of the latch formation 422 and the right edge 408 of the tab member 400 at an acute angle of approximately 55°. In this way, the rear edge 426 of the latch formation 422 defines an under-cut notch or a shoulder. When the tab member 400 is arranged in the package 100 in the closed position, the shoulder abuts a corresponding abutment edge 346 on the sleeve 300 and so acts as a locking formation.

Where the latch formation 422 meets the right edge 408 of the tab member 400, the spacing between the front and rear edges 424, 426 of the latch formation 422 defines the length of the latch formation 422. In the embodiment illustrated, the length of the latch formation 422 is approximately 20% of the length of the slot 416.

When a user applies an inward force to the latch formation 422, for example by squeezing the left and right latch formations 422 between their thumb and forefinger, the latch member 434 of the tab member 400 is resiliently deformed in an inward direction.

The slot 416 allows the latch member 434 to bend inwardly about the live hinges 436, such that a central portion of the latch member 434 occupies the space of the slot 416. In this way, the latch member 434 is effectively subjected to a three-point bend, with outward bending moments being applied at the live hinges and an opposed inward bending moment being applied at the latch formation 422 (i.e. at the centre of the latch member 434) by the user's finger or thumb.

The extent of deflection of the latch member 434 is therefore restricted by the width of the slot 416. The width of the slot 416 is selected to be narrow enough that deflection of the latch member 434 is restricted to a degree of deflection that is within the elastic limits of the latch member 434.

This bending of the latch member 434 allows the latch formation 422 to be moved in an unlatching direction L that extends substantially orthogonally to the left and right edges 406, 408 of the tab member 400.

In this way, the latch formation 422 is naturally and resiliently biased outwardly in a first, engaged position in which the front, rear and outer edges 424, 426, 428 of the latch formation 422 protrude outwardly beyond the right edge 408 of the tab member 400. Upon application of an inward force to the latch formation 422 by a user, the latch formation 422 can be resiliently moved in the unlatching direction L to a second, disengaged position, in which the outer edge 428 of the latch formation 422 lies substantially flush with, or inwardly of, the right edge 408 of the tab member 400. When the inward force is removed, the latch formations 422 return to the first, engaged position once more.

The sheet-like configuration of the tab member 400 means that it can be formed from a single sheet of material, for example by a simple process of cutting or stamping. The sheet material itself is inexpensive, and the manufacturing process is fast, efficient and similarly inexpensive. Alternatively, the tab member 400 could be made by other inexpensive methods, for example by injection moulding a plastics material. In this way, the cost of the package can be kept relatively low. Furthermore, the latch-carrying component is so thin that it takes up only minimal space in the package when stacked with other components such as the blister pack, thereby reducing its size, and improving its aesthetic appeal.

Referring now to FIG. 6, in the assembled package the tab member 400 is also provided with an information booklet 500 that is bonded to the upper side 410 of the tab member 400. The information booklet 500 conveniently provides information relating to the hazardous material that is stored in the assembled package 100.

The information booklet 500 comprises a spine 502 that is arranged proximal to a front edge 404 of the tab member 400, and an opposed openable end 504. The information booklet 500 is bonded to the upper surface 410 of the tab member 400 at a bonding region 506 adjacent to the spine 502. As shown in FIG. 6, when the information booklet 500 is bonded to the tab member 400, the openable end 504 of the information booklet 500 stops short of the rear end 402 of the tab member 400, such that a portion of the upper side 410 of the tab member 400 is uncovered by the information booklet 500.

In the embodiment shown, an optional retainer in the form of an adhesive label 508 is provided over the openable end 504 of the information booklet 500. When the information booklet 500 is closed, the adhesive label 508 is arranged to extend over the openable end 504 of the information booklet 500 and on to the upper side 410 of the tab member 400. In this way, the adhesive label 508 retains the information booklet 500 in a closed position. A user can open the information booklet 500 by peeling the adhesive label 508 away from the upper side 410 of the tab member 400. The adhesive label 508 can then be re-adhered to the upper side 410 of the tab member 400 to retain the information booklet 500 in the closed position once more.

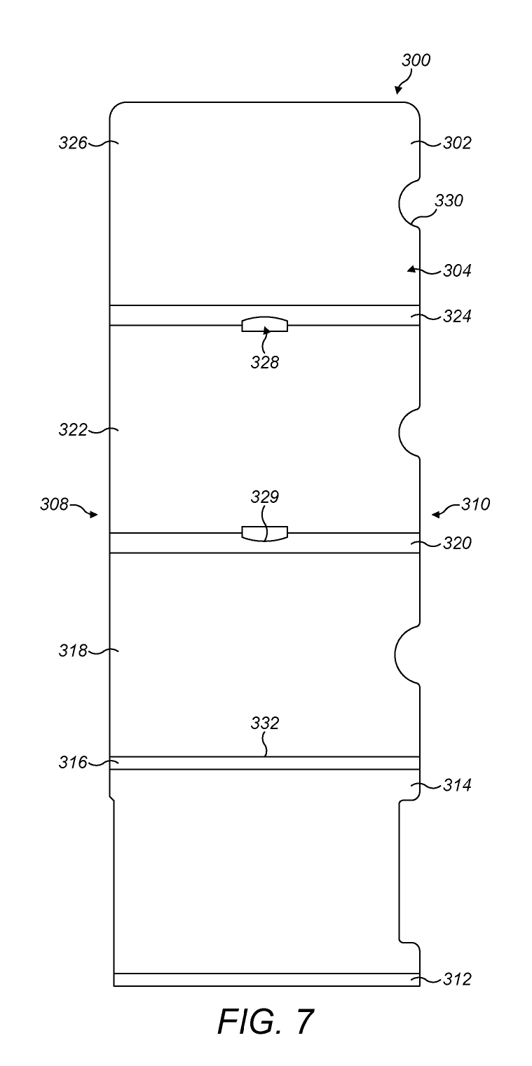

Referring now to FIG. 7, the sleeve 300 comprises a flat blank 302, which has a first or inner surface 304 on one side and a second or outer surface (not visible in FIG. 7) on the other side. The sleeve 300 is manufactured by cutting and creasing or scoring a sheet of flexible cardboard, plastics, tear-resistant laminate, or other material. In the embodiment shown, the sleeve 300 is made from a 0.5 mm thick mineral-filled polypropylene sheet, such as that sold under the registered trade mark PRO-Print. In this way, the sheet is flexible enough to allow for the bending that is necessary to form the sleeve 300, but is stiff enough to provide structural support. The material is also tear-resistant, to guard against the possibility of a child accessing the hazardous material in the blister-pack by tearing the sleeve 300 of the package.

The blank 302 comprises a front end 308 and a rear end 310 and consists of eight integral, substantially oblong sections or panels 312, 314, 316, 318, 320, 322, 324, 326, each extending from the front end 308 to the rear end 310 of the blank 302. Four of the sections, namely a divider 314, a lower inner wall 318, an upper wall 322 and a lower outer wall 326 are relatively wide, and four, namely a right inner wall 312, a left inner wall 316, a right outer wall 320, and a left outer wall 324, are relatively narrow. All of the sections 312, 314, 316, 318, 320, 322, 324, 326 are of substantially the same length: that length is greater than the width of the sections in the drawings, but it need not be greater.

The sections 312, 314, 316, 318, 320, 322, 324, 326 of the blank 302 are integral and demarcated from each other by folds or scores 332. The folds 332 are all made such that the first surface 304 of the flat blank 302 lies inward and the sleeve 300 is formed into a fully-folded configuration by folding the flat blank 302 along the folds 332 successively in a coil-like manner.

The blank is provided with two substantially oblong apertures 328. A first aperture 328 is arranged to straddle the score 332 between the left outer wall 324 of the sleeve 300 and the upper wall 322 of the sleeve 300. In this way, the aperture 328 extends a short distance into the upper wall 322, and a short distance into the left outer wall 324. A second aperture 328 straddles the score 332 between right outer wall 320 and the upper wall 322, such that the aperture 328 extends a short distance into the upper wall 322 and a short distance into the right outer wall 320. A lower edge 329 of each aperture 328, arranged on the right outer wall 320 or left outer wall 324, is non-linear and curved downwardly, such that a central portion of each aperture 328 extends further into the left or right outer wall 324, 320, than its end portions. This facilitates finger or thumb access to the aperture.

Each aperture 328 is disposed centrally between the front and rear ends 308, 310 of the blank 302, and is of a length that is slightly greater than the length of a latch formation 422 of the tab member 400. In this way, in the assembled package 100, the latch formation 422 can be received in the aperture 328.

The upper wall 322 and the lower inner and outer walls 318, 326 of the sleeve 300 each comprise a curved indentation 330 at the rear end 310 of the blank 302. When folded, the curved indentations 330 of the sections 318, 322, 326 are aligned with each other, so as to form a curved indentation of the folded sleeve 300. In the assembled package 100, this indentation aligns with the curved indentation 212 of the blister-pack 200.

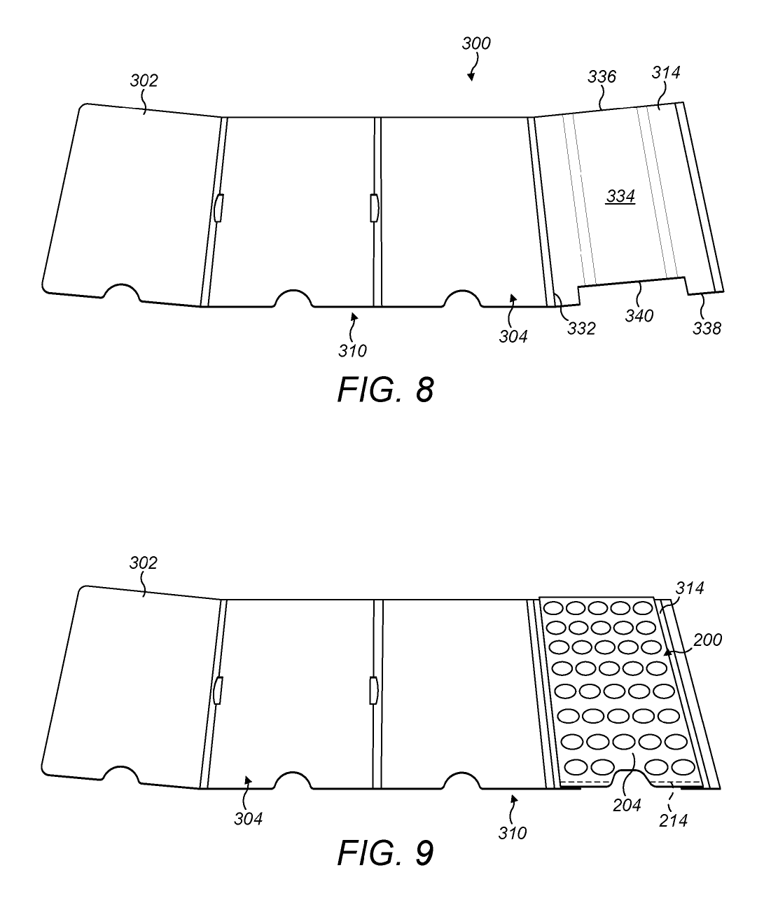

As best seen in FIG. 8, the divider 314 of the sleeve 300 supports an endless belt 334, to which the blister-pack 200 and the tab member 400 are attached as will be described. The belt 334 is typically a strip of a low-friction sheet material such as plastics film, e.g. polypropylene sold under the trade mark Treofan GND, and runs parallel to, and within, the folds 332 bordering the divider 314, on both surfaces of the flat blank 302, sliding around forward-facing and rearward-facing edges 336, 338 of the divider 314. Thus, the belt 334 passes around the divider 314 along a longitudinal belt path. To aid alignment of the belt 334 in the belt path, the divider 314 comprises a waist or cut-out 340 at the rearward-facing edge 338.

Before the flat blank 302 is folded along its folds 330 to bring the sleeve 300 into the fully folded configuration, the blister-pack 200 and the tab member 400 are attached to the belt 334, as illustrated in sequential FIGS. 8 to 13 as follows.

With reference to FIGS. 8 and 9, the blister-pack 200 is initially placed on the belt 334 of the divider 314, such that the upper side of the blister-pack faces the first surface 304 of the blank 302, and the blisters 202 face upwardly. The belt 334 is bonded to the blister-pack 200 at a first bonding point 214, which joins a rear section of the blister-pack 200 to the belt 334 where the belt 334 overlies the first surface 304 of the divider 314 near the rear end 310 of the blank 302.

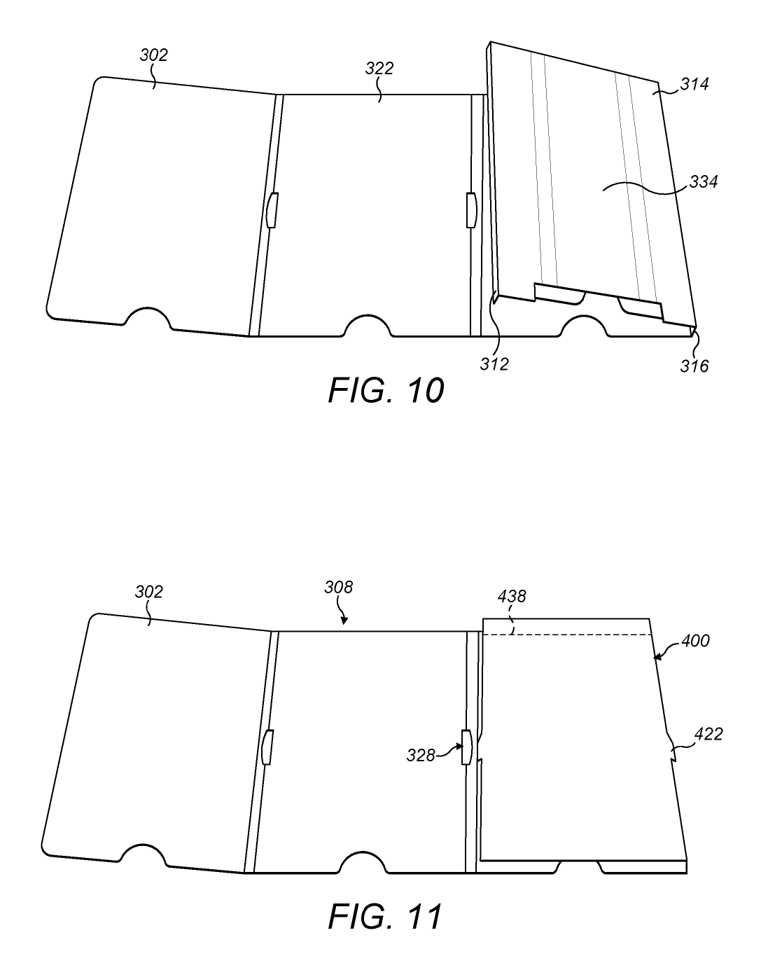

Thereafter, as illustrated in FIG. 10, the right inner wall 312, the divider 314, and the left inner wall 316 of the blank 302 are folded over the blister-pack so that the belt 334 of the divider 314 is aligned with the blister-pack 200.

Referring to FIG. 11, the tab member 400 is then arranged on the belt such that the latch formations 422 align with the oblong apertures 328. The tab member 400 is bonded to the belt at a second bonding point 438, where the belt overlies the divider near the front end 308 of the blank 302.

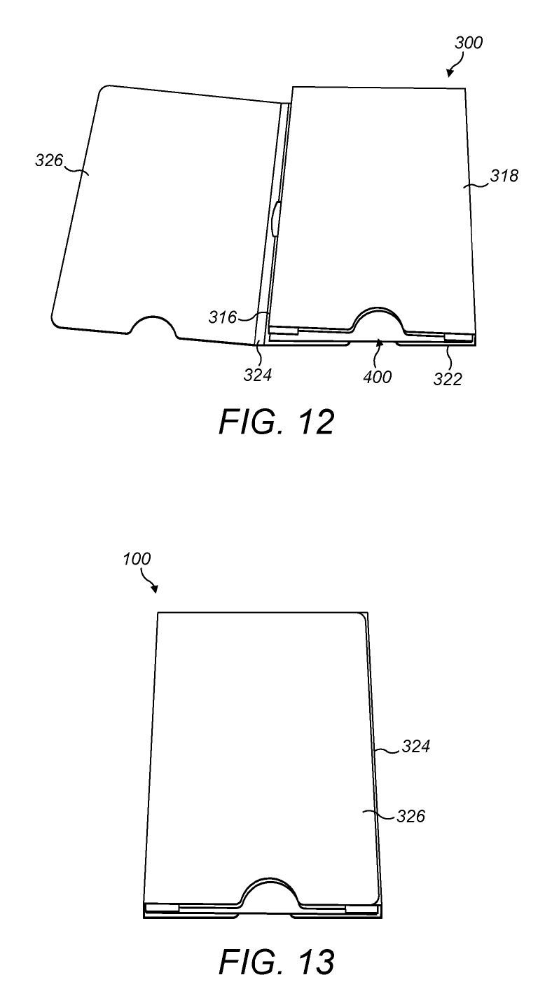

Next, as illustrated in FIGS. 12 and 13, the upper wall 322 of the sleeve 300 is folded over the tab member 400. Finally, the left outer wall 324 and the lower outer wall 326 are folded over. To complete assembly of the package 100, the left outer wall 324 is bonded to the left inner wall 316, and the lower outer wall 326 is bonded to the lower inner wall 318. Alternatively, the bonding between the left outer wall 324 and the left inner wall 316 may be omitted.

Referring again to FIGS. 1 to 5, in the assembled package 100 the blister-pack is housed within a lower passage 342 of the sleeve 300 whilst the tab member 400 is housed in an upper passage 344 of the sleeve 300. The divider 314 of the sleeve 300 separates the upper passage 344 and the lower passage 342.

The apertures 328 of the sleeve 300 are disposed on upper portions of the left and right outer walls 324, 320 of the sleeve 300, and hence lie adjacent the upper passage 344. In this way, in the assembled package 100, the left latch formation 422 of the left latch member 434 is received by the aperture 328 of the left outer wall 324, whilst the right latch formation 422 of the right latch member 434 is received by the aperture 328 of the right outer wall 320.

Because of the curved lower walls 329 of the apertures 328, a central portion of the apertures 328 extends below the upper passage 344, to reveal portions of the left and right inner walls 312, 316. In this way, the apertures 328 effectively provide an indent 345 below each latch formation 422. In use, this indent 345 allows a user's fingers or thumbs to access the latch formations 422 more easily, facilitating depression of the latch formations 422.

Referring more particularly to FIGS. 1 and 2, the assembled package 100 can be brought from a fully-closed state shown in FIG. 1, in which the content of the blister-pack 200 is inaccessible, into a fully-open state shown in FIG. 2, in which the content of the blister-pack 200 is accessible. To provide the desired child resistance, the latch formations 422 act in synergy with the belt 334 and divider 314 (shown in FIG. 10) of the package 100 to make it difficult for children to bring the package 100 from the closed state into the open state. Yet, adults find it easy to open the package 100 even if they are infirm or lack dexterity.

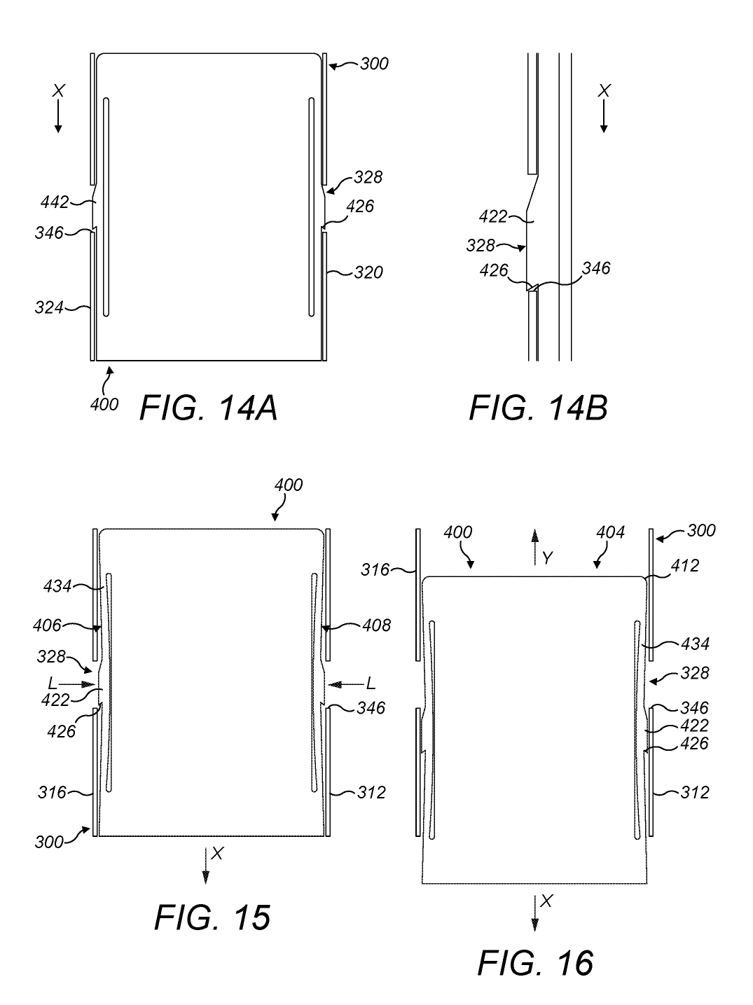

Referring now to FIG. 14A, when the latch formations 422 are in the engaged state, they are located in the apertures 328 of the left and right outer side walls 324, 320 of the sleeve 300, with the rear edges 426 of the latch formations 422 protruding into the apertures, and facing rear edges 346 of the apertures 328.

If a user attempts to move the tab member 400 in the direction of arrow X when the latch formations 422 are in their engaged state, the rear edges 426 of the latch formations 422 bear against the respective rear edges 346 of the apertures 328, as shown in FIG. 14B which prevents movement of the tab member 400 in the direction of arrow X. If a user continues to attempt to force the tab member in the direction of arrow X once the rear edges 426 of the latch formation 422 is already bearing against the rear edge 346 of the apertures 328, the inclination of the rear edge 426 of the latch formation 422 forces the latch formations 422 outwardly, further away from the disengaged state.

Movement of the tab member 400 in direction X can only occur when the latch formations 422 are simultaneously brought into their disengaged state by a user pressing the latch formations 422 towards each other in a squeezing action between thumb and forefinger, as shown in FIG. 15. As the user squeezes the latch formations 422, the latch members 434 move in the unlatching direction L, which is substantially orthogonal to the side edges 406, 408, and is in the plane of the tab member 400. The latch members are retained in this plane at least in part by the upper passage. In other words, the divider 314 and the upper wall 322 (visible in FIG. 10) of the sleeve 300 counteract any out-of-plane flexibility of the sheet to retain the latch members 434 in the plane of the tab member 400.

By moving the latch members 434 in the unlatching direction, the latch members 434 are moved into the disengaged state. In the disengaged state, the rear edges 426 of the latch formations 422 are arranged inwardly of the inner walls 312, 316 of the sleeve 300. In this way, when the user moves the tab member 400 in the direction of arrow X, the rear edges 426 of the latch formations 422 do not abut the rear edges 346 of the apertures 328, and the tab member 400 and hence the blister-pack are free to slide within the sleeve 300 as illustrated in FIG. 16.

Referring again to FIGS. 1 to 3, the belt supported by the divider links sliding movement of the tab member 400 and the blister-pack 200 as described in the Applicant's European Patent No. EP1140639. Provided that the left and right latch formations 422 have been moved into their disengaged states as described above, the tab member 400 can be pulled in the direction of arrow X, aided by the indentations 330, 212 in the upper wall 322 of the sleeve 300 and the blister-pack 200. The tab member 400 may thereby be moved from the fully-closed state in direction X. The attachment between the tab member 400 and the belt causes the belt to turn about the divider.

The movement of the belt causes the blister-pack 200 to move in the direction of arrow Y, since the blister-pack 200 is also attached to the belt on the other side of the divider. When the first and second bonding points 214, 438 (not shown) reach the edges of the divider at the front and rear ends 104, 102 of the package 100, the tab member 400 can be pulled no further in the direction of arrow X and the blister-pack 200 can move no further in direction Y. The package 100 is then in the fully-open state (shown in FIG. 2).

The tab member 400 works synergistically with the latch formations 422 to provide child resistance. Users of the package 100 cannot easily apply force in direction Y through the latch formations 422. Instead, to gain access to the blister-pack 200, it is necessary to hold the left and right latch formations 422 in the disengaged state with one hand, and, simultaneously, to apply an opening force on the tab member 400 at the opposite end of the package 100 with the other hand. The force that is required to access the blister-pack 200, by moving it in direction Y, is reversed by the belt, such that an opposite opening force, in direction X, must be applied to the tab member 400 at an opposite end 102 of the package 100 whilst the latch formations 422 are simultaneously disengaged. In the embodiment shown, the child resistance is also augmented by the fact that the spacing between the latch formations 422 is great enough that a child could not easily depress both latch formations 422 simultaneously with one hand.

When the tab member 400 is moved back in the direction of arrow Y, the tab member 400 causes the belt to turn about the divider in an opposite direction, so that the blister-pack 200 moves in the direction of arrow X. When the bonding points reach the opposite edges of the divider 314, further movement of the blister-pack 200 in direction X is prevented and the package 100 is back in the fully-closed state. As the tab member 400 is moved in the direction of arrow Y, the radiused corners 412 at the front edge 404 of the tab member 400 (visible in FIG. 4) prevent the corners 412 from catching on the inner walls 316, 312 (visible in FIG. 7), facilitating smooth motion of the tab member 400.

If preferred, a user can push the blister-pack 200 in the direction of arrow X to close the blister-pack 200, which in turn pulls the tab member 400 back into the sleeve 300. The effect is the same, in that both the blister-pack 200 and the tab member 400 will return to the fully-closed state in which the blister-pack 200 is inaccessibly housed within the sleeve 300.

When the blister-pack 200 is returned into the sleeve 300 from the fully-open state, the side walls 312, 316, 320 and 324 of the sleeve 300 initially push the left and right latch formations 422 into the disengaged state. The ramp-like taper of the front edges of the latch formations 422 enables this inward movement. However, when the latch formations 422 reach their associated apertures 328 in the side walls 320, 324, they are biased into the engaged state. Thus the left and right latch formations 422 engage in a snap fit with the sleeve 300 when the blister-pack 200 is returned into the sleeve 300 in direction X. The snap fit gives a clear indication to the user that the package 100 has been returned to the fully-closed state, and can therefore be stored safely.

As is evident from the above description, in addition to linking the blister-pack 200 and the tab member 400, the belt surrounding the divider delimits sliding movement of the blister-pack 200 and the tab member 400. The first and second bonding points reach opposite edges of the divider 314 at the front and rear ends 104, 102 of the package 100 in the fully-open and fully-closed states. As a result, the blister-pack 200 is prevented from moving in direction Y in the fully-open state. Similarly, the belt prevents the blister-pack 200 from moving in direction X in the fully-closed state.

Since in the fully-closed state the latch formations 422 of the tab member 400 additionally prevent movement of the tab member 400 in direction X, any hazardous materials held by the blister-pack 200 remain inaccessible to children. The divider and belt act in synergy with the latch formations 422 to provide child resistance.

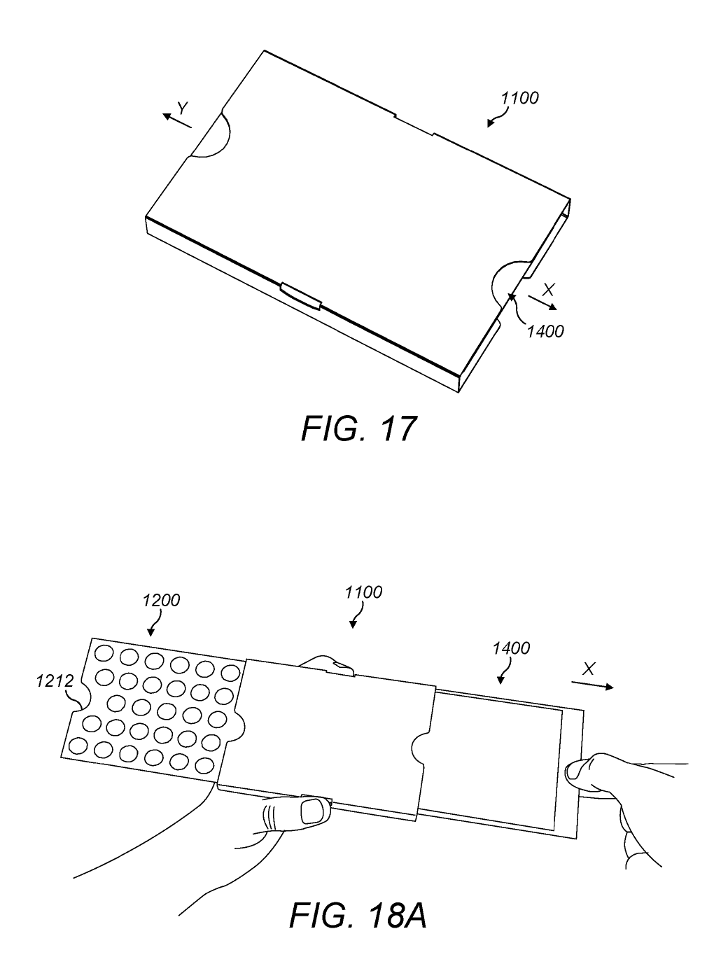

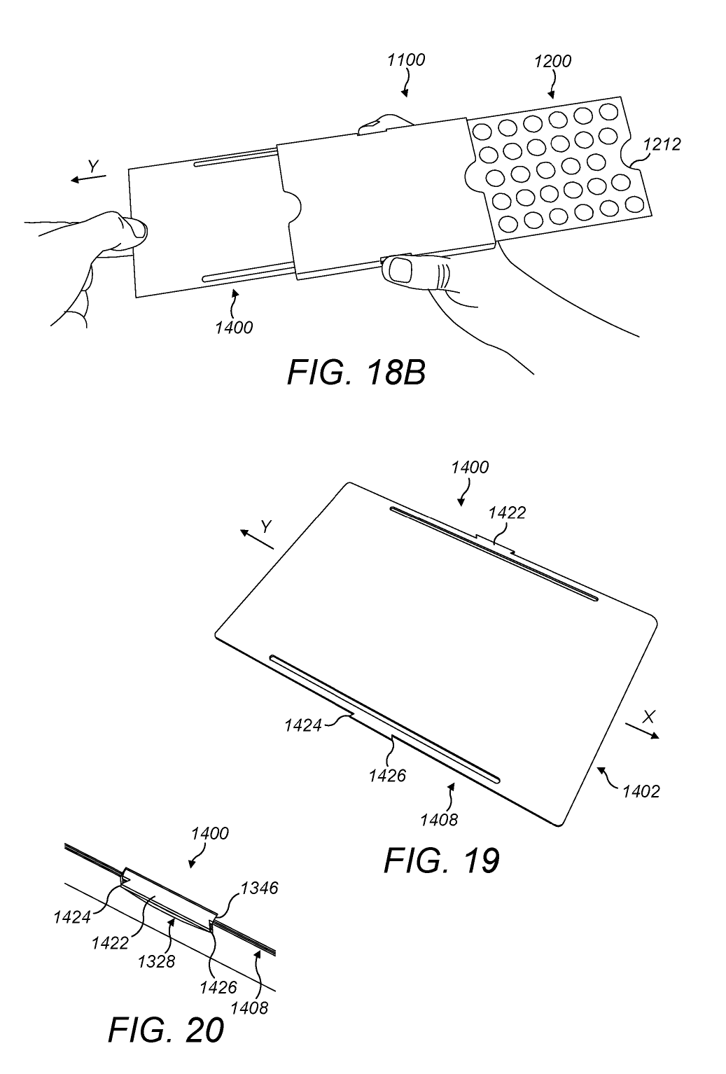

In another embodiment of the invention, namely a package 1100 illustrated in FIG. 17, the tab member 1400 and blister-pack 1200 are not bonded to the belt at ends of the belt path, but are instead bonded to the belt at a position that is substantially inward of those ends when the package 1100 is in the closed position. Consequently, in this package 1100, the tab member 1400 and the blister-pack 1200 are moveable in both the X and Y directions from the closed position, as shown in FIGS. 18A and 18B, in a manner described in the applicant's European Patent No. EP1984264.

A user can pull the tab member 1400 of this embodiment in the direction X to reveal a front end of the blister-pack 1200, or can pull the tab member 1400 in the direction Y to reveal a rear end of the blister-pack 1200. In this case, cut-outs 1212 are provided in both the left and right ends of the blister-pack 1200, to facilitate finger access to the tab member 1400 at both sides when the package 1100 is fully closed.

Specifically, the tab member 1400 is illustrated in FIGS. 19 and 20. The tab member 1400 is substantially that same as the tab member 400 of the previous embodiment, and differs only in the shape of the latch formations 1422.

The latch formations 1422 of the tab member 1400 are shaped so as to prevent movement of the tab member 1400 in either the X direction or the Y direction from the fully-closed position when the tab member 1400 is in the engaged state. To this end, in this embodiment, the front edge 1424 of each latch formation 1422 extends rearwardly towards the rear edge 1402 of the tab member 1400 and inwardly towards the centre of the tab member 1400, such that it meets the edge 1408 of the tab member 1400 at an acute angle. The rear edge 1426 of the latch formation 1422 extends inwardly and forwardly, such that the rear edge 1426 of the latch formation 1422 also meets the edge 1408 of the tab member 1400 at an acute angle, as in the previous embodiment.

In this embodiment, the front edge 1424 of each latch formation 1422 therefore defines an under-cut notch or shoulder that is a mirror-reflection of the shoulder defined by the rear edge 1426 of the latch formation 1422, and that acts as a locking formation. In this way, when a user attempts to move the tab member 1400 in the Y direction with the latch formation 1422 in the engaged state, the movement is prevented by the front edge 1424 of latch formation 1422 bearing against an edge 1346 of the aperture 1328 in the sleeve 1300.

Thus, the latch formations 1422 act to prevent movement of the tab member 1400 away from the closed position in either the X or the Y directions when the latch formations 1422 are in their engaged state, and thereby provide the necessary child resistance with respect to both directions. If a user attempts to force the tab member 1400 in either direction once the front or rear edges 1424, 1426 of the latch formation 1422 are already bearing against an edge 1346 of the aperture 1328, the taper of the front or rear edge 1424, 1426 of the latch formation 1422 forces the latch formation 1422 outwardly, further away from the disengaged state.

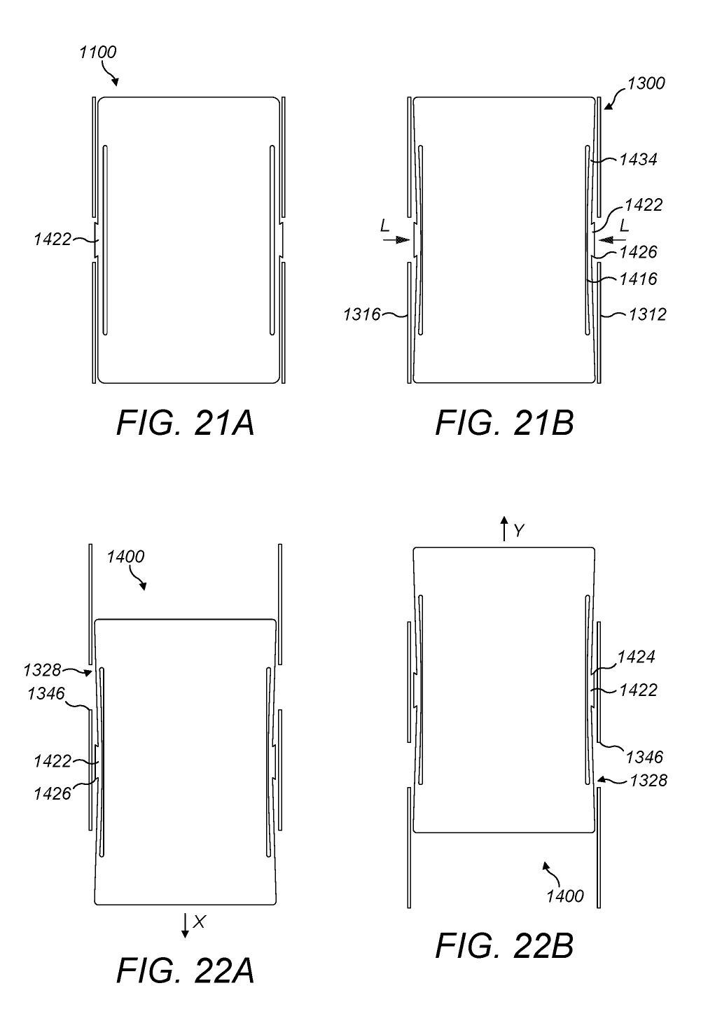

To open the package 1100, the latch formations 1422 must be simultaneously brought from their engaged state, shown in FIG. 21A into their disengaged state, shown in FIG. 21B, by a user pressing the latch formations 1422 towards each other in a squeezing action between thumb and forefinger, as in the previous embodiment. As the user squeezes the latch formations 1422, the latch members 1434 move in the unlatching direction L, deforming elastically into the slots 1416 and into the disengaged state.

In the disengaged state, the rear edges 1426 of the latch formations 1422 lie inwardly of the inner walls 1312, 1316 of the sleeve 1300. In this way, the user can move the tab member 1400 freely in the direction of arrow X as shown in FIG. 22A, without the rear edges 1426 of the latch formations 1422 engaging the rear edges 1346 of the apertures 1328. Alternatively, the user can move the tab member 1400 freely in the direction of arrow Y as shown in FIG. 22B, without the front edges 1424 of the latch formations 1422 engaging the front edges 1346 of the apertures 1328.

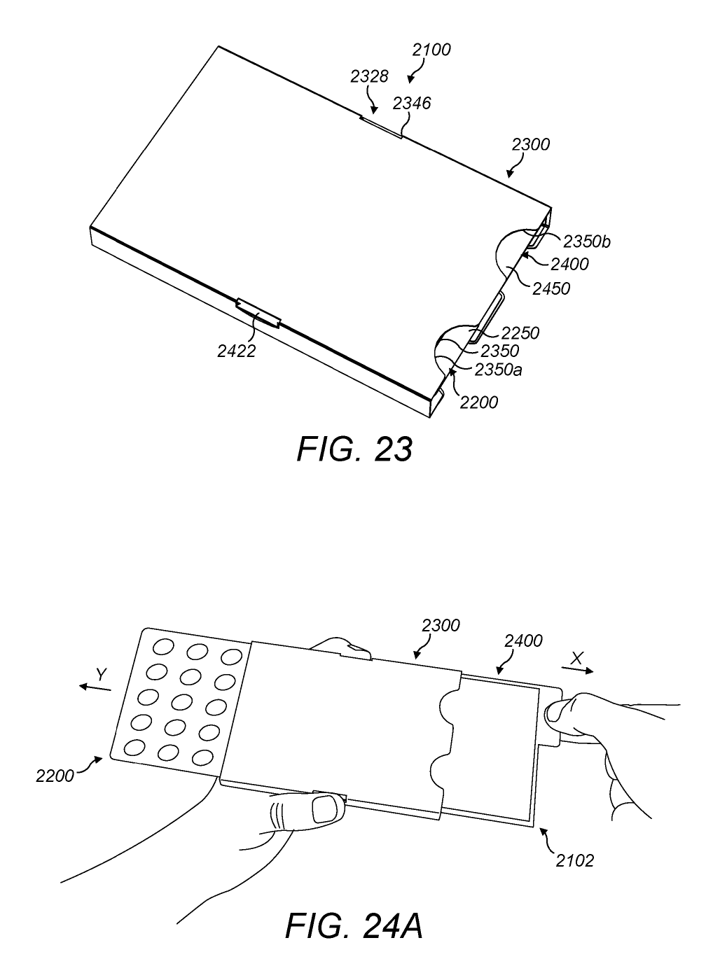

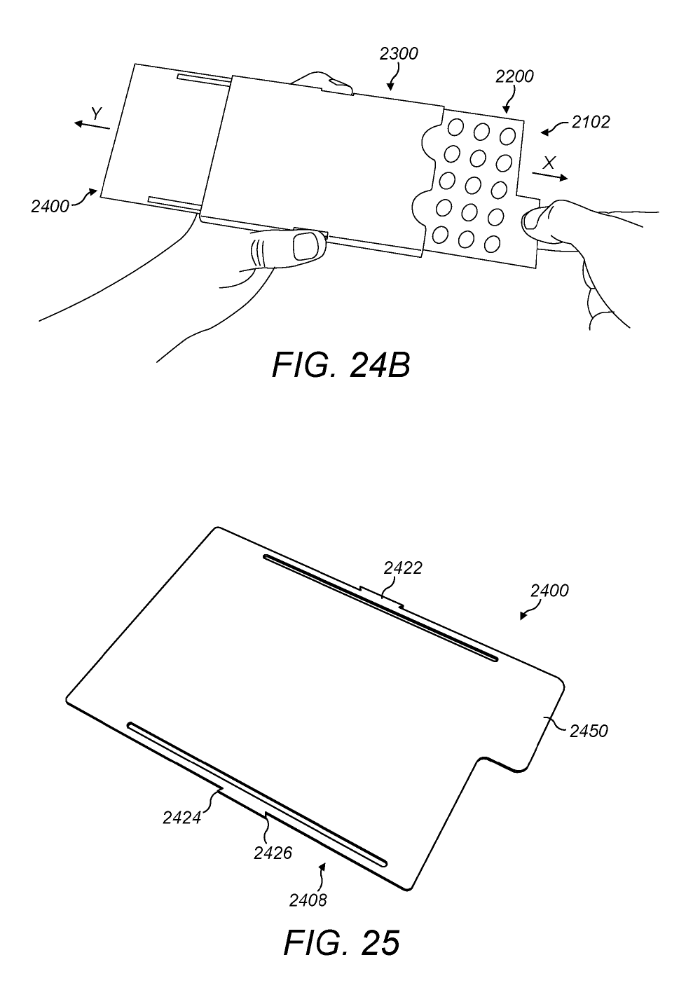

FIG. 23 illustrates another embodiment of the invention, namely a package 2100. In this package 2100, as in the previous embodiment, the tab member 2400 and blister-pack 2200 are not bonded to the belt at ends of the belt path, but are instead bonded to the belt 2334 at positions that are substantially inward of those ends when the package 2100 is in the closed position. In this way, the tab member 2400 and the blister-pack 2200 are moveable in both the X and Y directions from the closed position, as shown in FIGS. 24A and 24B.

In this case, a user can pull the tab member 2400 in the direction X to reveal a front end of the blister-pack 2200 and a rear end of the tab member 2400, as shown in FIG. 24A, or can alternatively pull the blister-pack 2200 in the direction X to reveal a rear end of the blister-pack 2200, and a front end of the tab member 2400, as shown in FIG. 24B.

The tab member 2400, blister-pack 2200 and sleeve 2300 are each specially adapted to permit finger access to both the tab member 2400 and the blister-pack 2200 at the rear end 2102 of the package 2100.

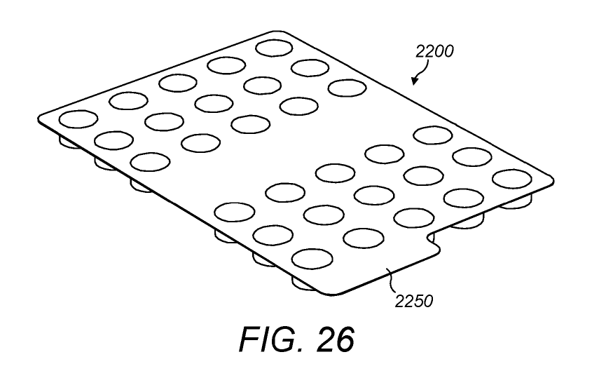

As shown in FIGS. 25 and 26, both the tab member 2400 and the blister-pack 2200 are provided with gripping formations 2450, 2250 at their respective rear ends. The gripping formations 2450, 2250 take the form of rearwardly-projecting tabs. The tab 2450 of the tab member extends across the right half of the rear end of the tab member 2400, while the tab 2250 of the blister-pack 2200 extends across the right half of the rear end of the blister-pack 2200.

Thus, when the tab member 2400 and the blister-pack 2200 are arranged one on top of the other in the package 2100, the tabs 2450, 2250 are at opposite sides of the package 2100 and do not fully overlie one another, thereby enabling a user to grip individually the tab 2450 of the tab member 2400 at the right side of the package 2100, and the tab 2250 of the blister-pack 2200 at the left side of the package 2100.

Referring back to FIG. 23, the sleeve 2300 of the package 2100 is provided with two curved indentations 2350 in the form of cut-outs at its rear end. A left cut-out 2350a provides finger access to the tab 2250 of the blister-pack 2200, and a right cut-out 2350b provides finger access to the tab 2450 of the tab member 2400. A user can access the tabs 2250, 2450 via the cut-outs 2350, to pull either the tab member 2400 or the blister-pack 2200 to access either the front or rear side of the blister-pack 2200 as required.

The latch formation 2422 takes the same form as the latch formation 1422 of the previous embodiment, such that both the front and rear edges 2424, 2426 of the latch formation 2422 meet the edge 2408 of the tab member 2400 at acute angles to define notches or shoulders. When the package 2100 is closed, if a user attempts to force the tab member 2400 in either direction with the latch formations 2422 in their engaged state, the shoulders bear against an edge 2346 of the aperture 2328 in the sleeve 2300 to prevent movement of the tab member 2400 and hence of the blister-pack 2200.

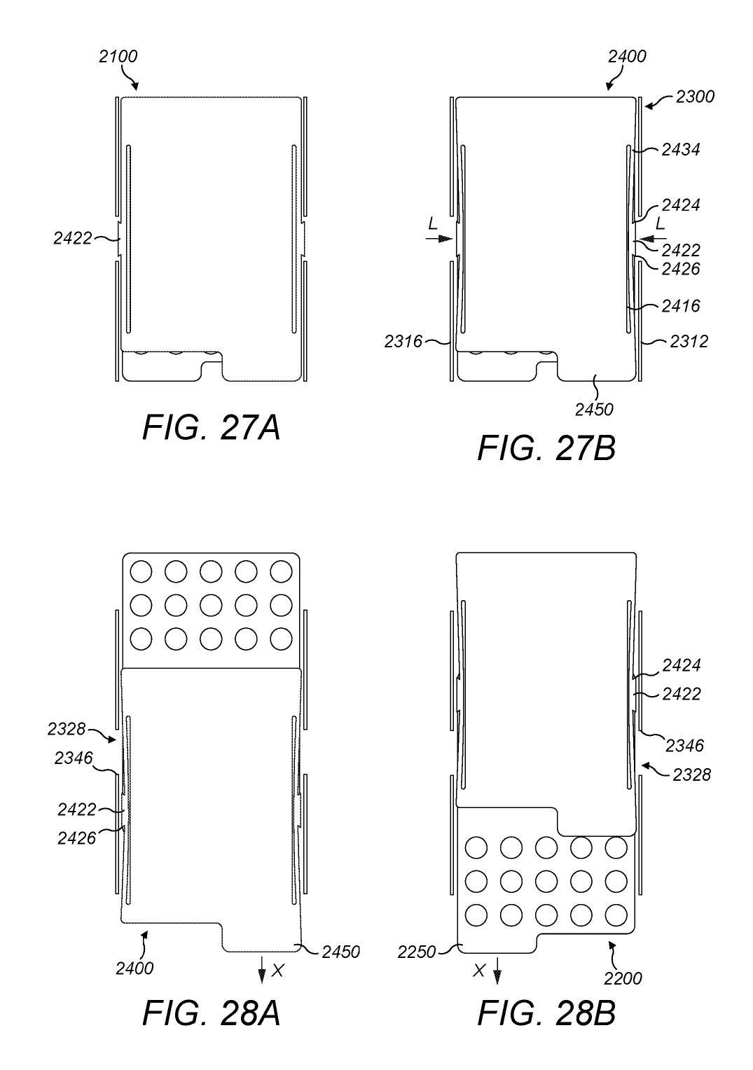

To open the package 2100, the latch formations 2422 must be simultaneously brought from their engaged state, shown in FIG. 27A, into their disengaged state, shown in FIG. 27B, by a user pressing the latch formations 2422 towards each other in a squeezing action between thumb and forefinger, as in the previous embodiment. As the user squeezes the latch formations 2422, the latch members 2434 move in the unlatching direction L, deforming elastically into the space provided by the slots 2416 and into the disengaged state.

In the disengaged state, the front and rear edges 2424, 2426 of the latch formations 2422 lie inwardly of the inner walls 2312, 2316 of the sleeve 2300. In this way, the user can grip the tab member 2400 via the tab 2450 and move the tab member 2400 freely in the direction of arrow X, as shown in FIG. 28A, without the rear edges 2426 of the latch formations 2422 engaging the rear edges 2346 of the apertures 2328. Alternatively, the user can grip the tab 2250 of the blister-pack 2200 and move the blister-pack 2200 freely in the direction of arrow X as shown in FIG. 28B, without the front edges 2424 of the latch formations 2422 engaging the front edges 2346 of the apertures 2328.

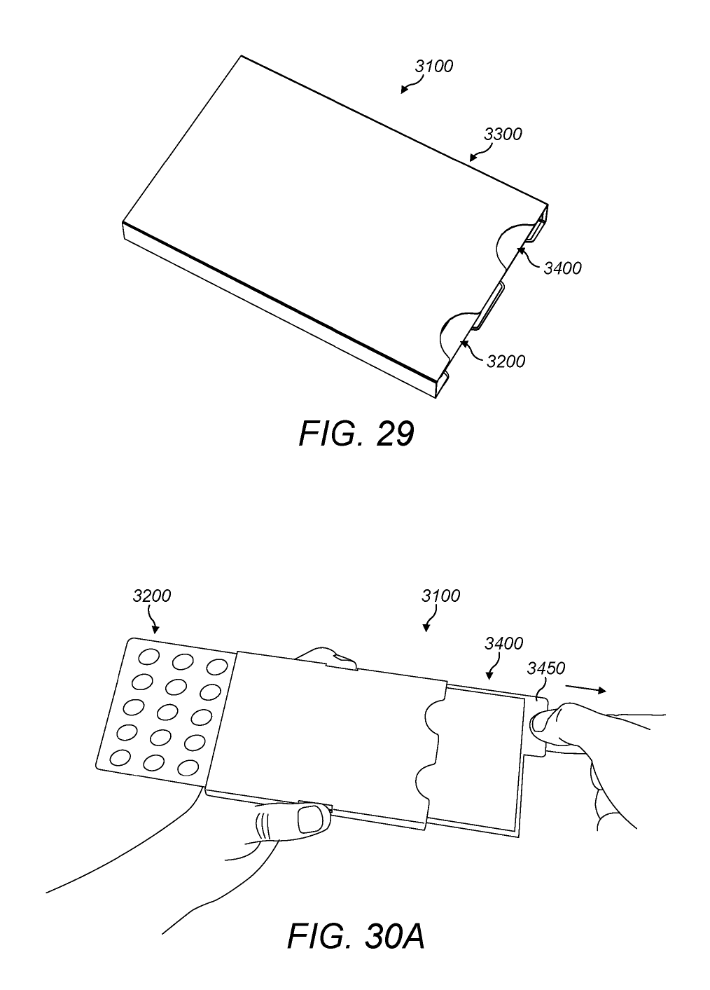

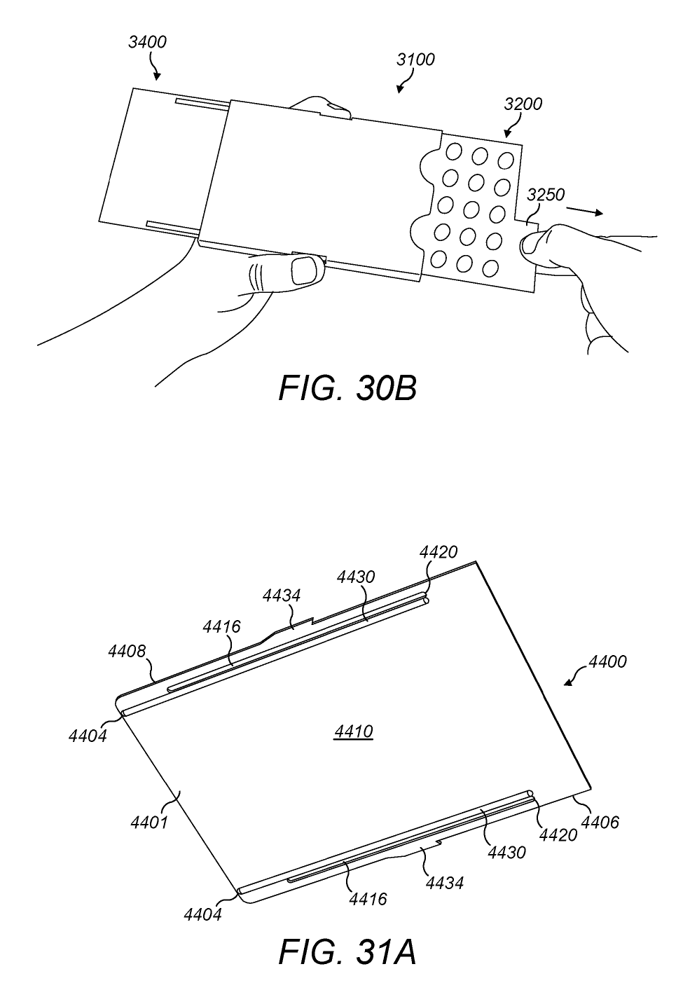

Finally, a further embodiment of the invention, namely a package 3100, is illustrated in FIGS. 29, 30A and 30B. The package 3100 is substantially the same as the package 2100 of the previous embodiment, except that the child-resistant functionality is omitted. In particular, as shown in FIG. 29, the latch members are omitted from the tab member 3400, and the apertures are omitted from the left and right sides of the sleeve 3300.

The tab member 3400 and the blister-pack 3200 can be moved out of the package 3100 using their respective tabs 3450, 3250, as shown in FIGS. 30A and 30B to give access to the front and rear sides of the blister-pack 3200 and the tab member 3400 as in the previous embodiment, but in this case without the need to depress latches at the side of the package 3100.

In this embodiment, the tab member 3400 may take the form of an additional blister-pack having a gripping formation, which may be a mirror-image of the blister-pack 3200.

Embodiments are also envisaged in which a single, larger cut-out is provided in the sleeve, which is large enough to provide finger access to both tabs. The tabs may also protrude from the sleeve to facilitate finger access.

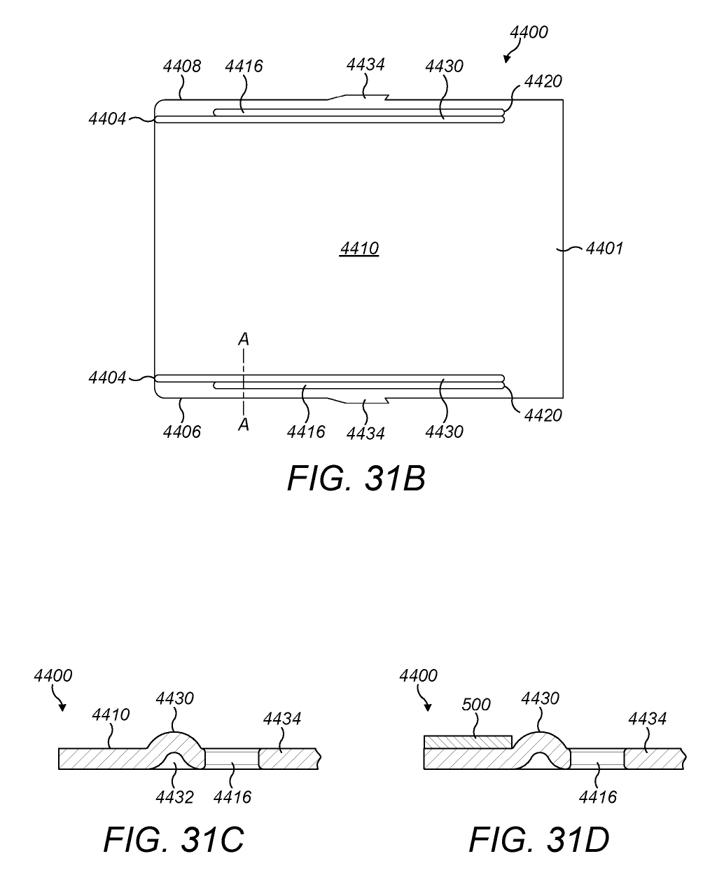

FIGS. 31A to 31D illustrate another tab member 4400 that can be incorporated into a package such as the package of FIG. 1. The tab member 4400 is substantially the same as the tab member 400 of FIG. 4, except that the tab member 4400 comprises ridges 4430 that protrude from the upper surface 4410 on the main body 4401 of the tab member 4400.

Each ridge 4430 is elongate and extends parallel to the left and right edges 4406, 4408 of the tab member 4400. Each ridge 4430 lies adjacent to, and inboard of, a slot 4416, and extends from the rear end 4420 of the slot 4416 to the front edge 4404 of the tab member 4400. In this way, the ridges 4430, 4432 cover substantially all of the portion of the tab member 4400 that protrudes from the package when the tab member 4400 is in the extended configuration.

It will be appreciated that the exact configuration of the ridges may be adapted according to certain considerations, including for example manufacturing considerations.

As shown in FIG. 31C, the ridge 4430 is defined by a fold in the tab member 4400. In this way, the underside of the tab member 4400 comprises a trough 4432 that corresponds to the ridge 4430 in the upper surface 4410.

As can be seen in FIG. 31D, in the example shown each ridge 4430 protrudes from the upper surface 4410 by a distance that is greater than the thickness of a booklet 500 that is attached to the tab member 4400. In this way, the effective total thickness of the tab member 4400 in an out-of-plane direction, including the ridges 4430 and the booklet 500, is equal to the thickness of the ridges 4430. The ridges 4430 therefore define a minimum thickness of the tab member 4400.

Fixing a minimum thickness of the tab member 4400 in this way ensures that when the tab member 4400 is incorporated into a sleeve having an upper passage of a particular depth, the clearance between the tab member and is no greater than a fixed amount (that amount being the difference between the depth of the upper passage and the minimum thickness of the tab member 4400. In this way, irrespective of the presence or thickness of the booklet, the tab member will fit snugly into the upper passage which helps to constrain the tab member 4400 within the passage, minimising movement of the tab member 4400 in the out-of-plane direction which assists the locking of the latch members as has already been described.

The ridges 4430 also facilitate automated high-speed feeding of tab members 4440 in the case that the packs are to be manufactured by machine.

Any of the tab members 400, 4400 described above may optionally be provided with an adhesive-assist feature towards the rear end of the tab member that facilitates adhesion of the booklet to the tab member. The adhesive-assist feature may for example be a recessed region or a pattern of one or more channels provided in the upper surface of the tab member.

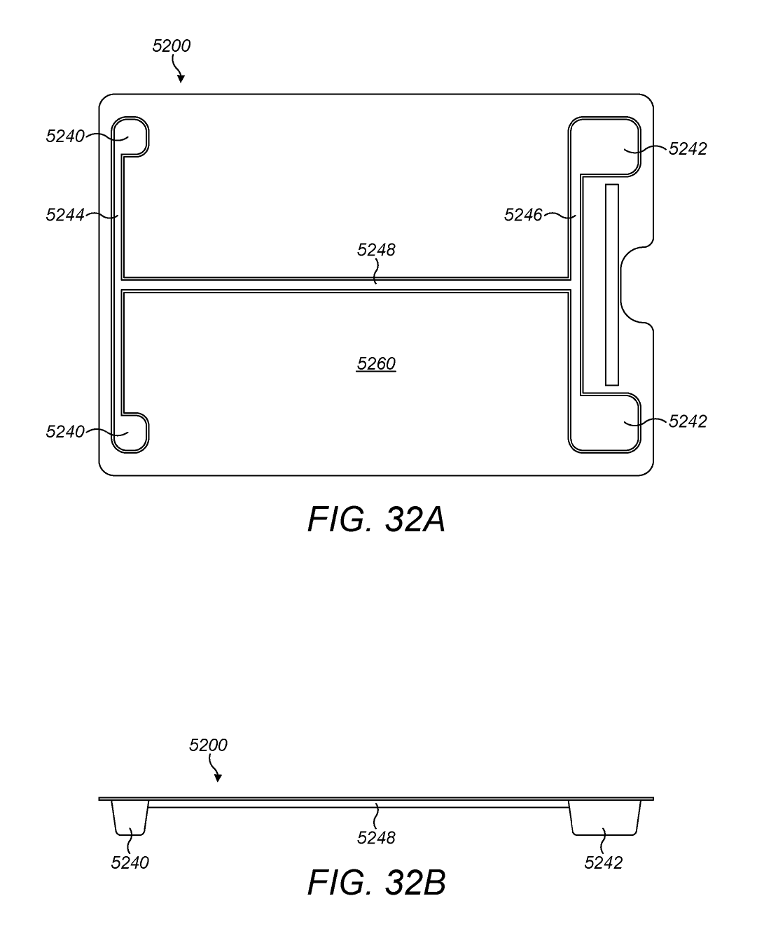

FIGS. 32A and 32B illustrate a blister pack 5200 that could be used instead of the blister pack 200 of FIG. 3. The blister pack 5200 comprises a pair of empty front blisters or pockets 5240 at left and right sides of the pack, and a pair of empty rear blisters or pockets 5242 at left and right sides of the pack.

The empty front and rear blisters 5240, 5242 are of the same depth in a direction perpendicular to the plane of the tab member. In particular, the depth of the empty front and rear blisters 5240, 5242 is selected so as to be at least as great as the depth typically required for a blister that houses a tablet. For example, the empty front and rear blisters 5240, 5242 may have a depth of approximately 8 mm.

A front ridge 5244, extends between the empty front blisters 5240. A rear ridge 5246, extends between the empty rear blisters 5242. A central ridge 5248 extends from the front ridge 5244 to the rear ridge 5246, down the centre of the blister pack 5200. The ridges 5244, 5246, 5248 are formed by long, thin channels that are contiguous with the empty front and rear blisters 5240, 5242, but have a depth that is less than the depth of the empty front and rear blisters 5240, 5242, as is evident in FIG. 32B. The ridges 5244, 5246, 5248 lend additional stiffness to the blister pack 5200, such that bending of the blister pack 5200 is difficult. The front ridge 5244 also acts to block the space between the sleeve and the blister pack 5200 at the front of the pack, thereby acting as a further barrier to the hazardous material and improving the child resistance of the package even further.

The rear blisters 5242 act as stabilising formations in the manner described in the Applicant's patent EP2154078. In particular, when the blister pack 5200 is contained in the package and is in the extended position, the rear blisters 5242 remain inside the sleeve and prevent the blister pack 5200 pivoting with respect to the sleeve.

Between and around the empty blisters 5240, 5242 and the ridges 5244, 5246, 5248 is a substrate region 5260. The substrate region 5260 can be populated with blisters that house articles such as tablets, for example blisters of the type shown in the blister pack of FIG. 3, according to the needs of a particular package. These blisters may be of any suitable size and may be arranged in any suitable arrangement.

Since the depth of the empty front and rear blisters 5240, 5242 has been selected to be greater than the depth of blisters that will typically be applied to the substrate area 5260, in most cases, the empty front and rear blisters 5240, 5242 will be the thickest part of the blister pack 5200. In this way, the empty front and rear blisters 5240, 5242 serve to define the thickness of the blister pack 5200, thereby giving the blister pack 5200 a fixed thickness that is independent of the depth of the blisters that house the tablets.

The dimensions of the sleeve that is to be used in conjunction with the blister pack 5200 can be selected to match this fixed thickness. The blister pack 5200 can therefore fit snugly and reliably into the same sleeve irrespective of the size of the tablets to be housed in the blisters. This is particularly beneficial because a snug fit is important to maintain child resistance; if there is too much space between the blister pack 5200 and the sleeve a child may be able to insert their hands into the sleeve to gain access to the blister pack and the articles it houses.

Fixing the depth of the blister pack 5200 means that this snug fit, and hence a high level of child resistance, can be maintained even for small tablets, without the need to adapt the sleeve dimensions according to the tablet size. A standard sleeve can therefore be applied to most packs, irrespective of contents, facilitating manufacture in the event that a single manufacturing facility is to manufacture packages containing different items.

Furthermore, because the thickness of the blister pack 5200 is defined using both front and rear blisters 5240, 5242, the blister pack 5200 has four points on which it can rest when it is placed on a surface. This is particularly useful when multiple blister packs 5200 are to be stacked one-on-top-of-another ready to be assembled into a pack by machine.

In this case, having points of equal thickness at both the front and the rear means that the blister packs will lie horizontally when stacked, which facilitates feeding of the blister pack 5200 from the stack and through the machine for assembly. Embodiments are also envisaged in which the blister pack has three point of greatest thickness, for example, in which only one front or only one rear blister is provided.

In the event that the blisters provided on the substrate area 5260 have a depth that is equal to the depth of the empty front and rear blisters 5240, 5242, the thickest parts of the blister pack will be all blisters on the substrate area 5260 of the blister pack 5200 as well as the empty blisters 5240, 5242. In this case, the empty front blisters 5240 may be omitted, since the blisters of the substrate area 5260 are of sufficient depth to ensure horizontal arrangement of the blister pack 5200 when stacked. The empty rear blisters 5242 may be retained to provide stabilisation.

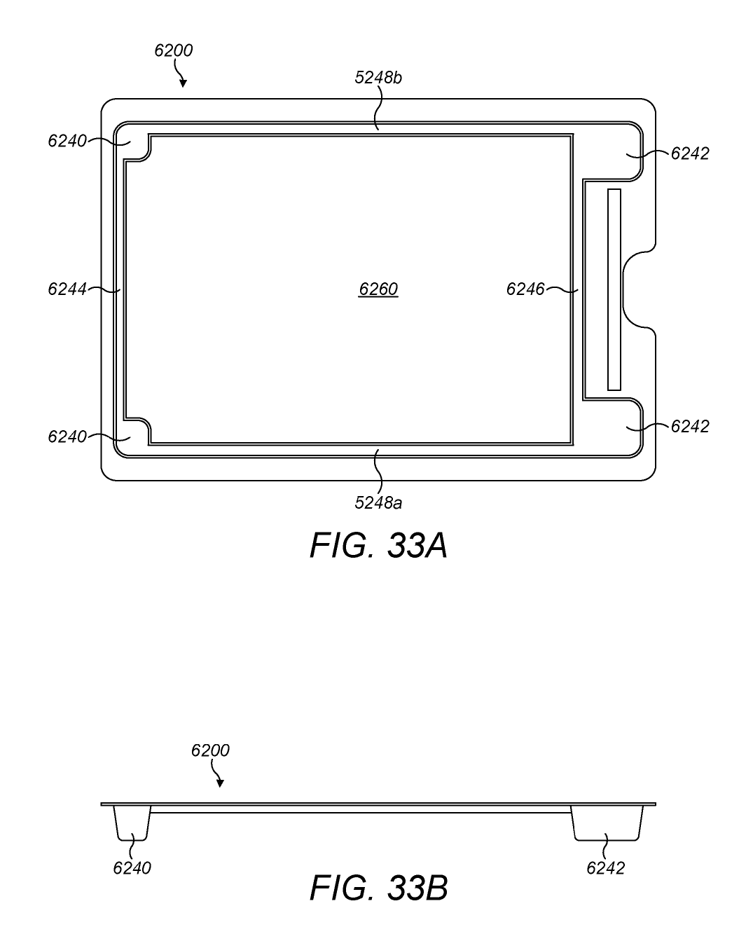

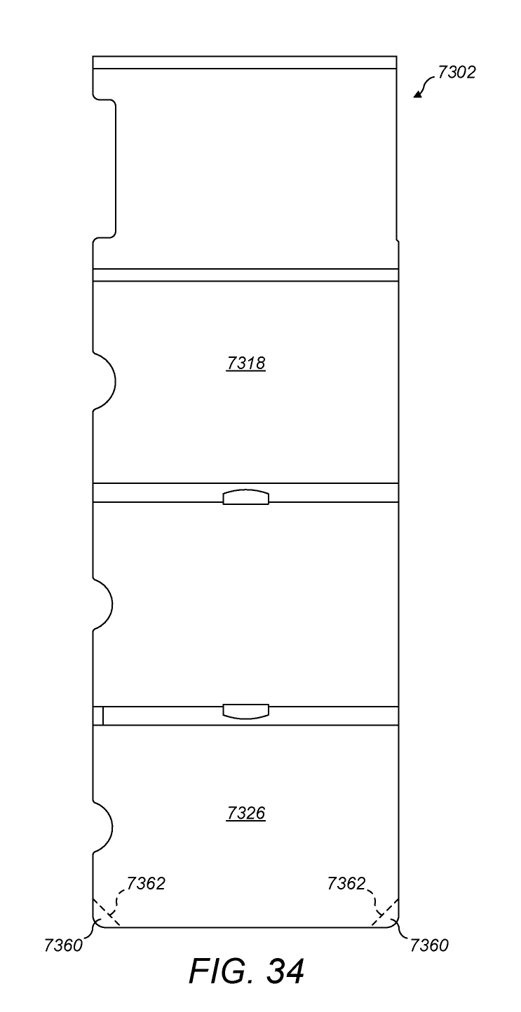

FIGS. 33A and 33B illustrate another alternative blister pack 6200. The blister pack 6200 of FIGS. 33A and 33B is substantially the same as that of FIGS. 32A and 32B, except for the arrangement of ridges. In this case, the central ridge is omitted and left and right ridges 5248a and 5248b are provided instead. The left ridge 5248a runs from a left front blister to a left rear blister, while the right ridge 5248b runs from a right front blister to a left front blister. Arranging ridges at the left and right sides of the blister pack in this way provides additional stiffness and in particular provides additional resistance to torsion of the blister pack 6200.

The blister packs 5200, 6200 of FIGS. 32A and 32B and FIGS. 33A and 33B may be incorporated into any type of package, including sliding and non-sliding packages, and need not necessarily be incorporated into the a package of the type shown in FIG. 1.

FIG. 34 illustrates an alternative sleeve blank 7302 for making an alternative sleeve of a package. The sleeve blank 7302 is substantially the same as the sleeve blank 302 of FIG. 7 except that, on the section of the sleeve blank 7302 that will define the lower outer wall 7326 of the sleeve, corners 7360 of the panel 7326 are perforated along a perforation line 7362.

In the assembled sleeve, the lower outer wall 7326 is glued to the lower inner wall 7318, such that the perforated corners 7360 are visible. The perforated corners 7360 give the false appearance of being a ‘peel’ region for entry into the package 7300. If a child encounters the package 7000 and attempts to open it, the child will be distracted by the perforated corners 7360 and will attempt to peel the corners 7360 away from the lower inner wall 7318. However, even if the child is successful in peeling away the corner, they will not be successful in obtaining access to the contents of the package 7000.

The perforated corners 7360 therefore act as a defeat feature that draws attention away from the true access mechanism and that can be sacrificed without allowing access to the hazardous contents of the package.

In the embodiments shown, the child resistance provided by the synergy between the tab member and the latches is augmented by the fact that the spacing between the latch formations is great enough that a child could not easily depress both latch formations simultaneously with one hand. However, this width of the package merely augments the child resistance, and is not a necessary feature. For example, in relatively small packages, the width of the package may not be large enough to augment the child resistance in this manner, and in such small packages the presence of the latches is sufficient to provide ample child resistance.

Although in the embodiments described the package is provided with two latch members and two latch formations, it will be appreciated that in some embodiments only a single latch formation and/or latch member need be provided. In other embodiments, more than two latch formations or latch members may be provided. For example, a single latch member may support more than one latch formation. In another embodiment, each side of the tab member may have two slots that provide two latch members, and each latch member may support one of more latch formations. The latch formations need not be provided at a central position, but may be provided at any suitable location, for example, towards the front or rear end of the package.

In alternative embodiments, the lower outer wall may be omitted from the sleeve blank, and the sleeve may be secured by bonding the right inner and outer walls.

It is envisaged that, as an alternative or addition to the information booklet, an upper surface of the tab member may be printed, for example with information relating to the hazardous material, or with promotional material.

Embodiments are also envisaged in which the tab member incorporates a blister-pack. For example, the latch members and latch formations may be formed in the blister-pack, by forming the blister-pack to the required shape. Alternatively, the tab member may consist of a blister pack and a fitting supporting the latch members and latch formations that can be fitted to the blister pack, for example at the sides, front or rear of the blister pack.

It is emphasised that any of the components described above may be used in isolation from the other components. The components may also be used in any suitable combination. For example, any of the tab members described above may be incorporated into a package with any suitable type of support, which may include, but is not limited to, any of the blister packs described above. Further more, any of the blister packs described above may be used in isolation in any suitable type of package, which may be a sliding package or a non-sliding package.

It should be appreciated that various other modifications and improvements can be made without departing from the scope of the invention as defined in the claims.

1-54. (canceled)

55. A tab member for use in a latchable slidable package, the tab member having opposed major faces connected by opposed side edges and comprising;
a body portion; and
a cut-out defining a resiliently deformable latch member connected to the body portion by at least one live hinge, the latch member incorporating a latch formation that is moveable by a user in an unlatching direction substantially orthogonal to at least one side edge;
wherein the tab member is substantially planar, and the unlatching direction lies substantially in a plane of the tab member.

56. The tab member of claim 55, wherein the latch member incorporates at least an edge portion of said side edge.

57. The tab member of claim 56, wherein the latch formation comprises a locking formation of the edge portion.

58. The tab member of claim 57, wherein the locking formation lies at an acute angle to an adjacent portion of the side edge.

59. The tab member of claim 56, wherein the latch formation comprises a ramp formation opposed to the locking formation that lies at an obtuse angle to an adjacent portion of the side edge.

60. The tab member of claim 55, wherein the cut-out is an elongate slot substantially aligned with and arranged near the side edge.

61. The tab member of claim 55, wherein the latch member is connected to the body portion by a pair of live hinges arranged at opposed ends of the latch member.

62. The tab member of claim 55, wherein the latch formation is integral with the latch member.

63. The tab member of claim 55, wherein the latch member is integral with the body portion.

64. The tab member of claim 55, wherein a second latch member is provided on an opposed second side edge of the tab member.

65. The tab member of claim 55, wherein the tab member is a cut or stamped sheet.

66. The tab member of claim 55, wherein the tab member incorporates a blister-pack.

67. The tab member of claim 55, wherein the tab member comprises at least one ridge that protrudes out of the plane of the tab member.

68. A latchable package comprising:
a support for supporting one or more items;
a structure for selectively blocking access to the or each item; and
the tab member of any preceding claim;
wherein the tab member is coupled to the support such that movement of the tab member with respect to the structure in a driving direction effects movement of the support in an access direction different to the driving direction, such that the support is moveable between a secured position in which access to the item is blocked by the structure and an access position in which the item is accessibly clear of the structure; and
wherein at least one side edge of the tab member is substantially aligned with the driving direction and the latch formation is moveable by a user in an unlatching direction substantially orthogonal to the side edge between an engaged state in which the tab member is prevented from moving in the driving direction and a disengaged state in which the tab member is allowed to move in the driving direction.

69. The package of claim 68, wherein the structure comprises an abutment edge, and a locking formation of the tab member bears against the abutment edge to prevent the tab member from moving in the driving direction.

70. The package of claim 69, wherein the structure comprises an aperture that receives the latch formation when the package is in the secured position and the latch formation is in the engaged state, and wherein the aperture defines the abutment edge of the structure.

71. The package of claim 68, wherein the structure comprises a first passage that houses the support and a second passage that houses the tab member, the tab member being arranged in the second passage with a close sliding fit.

72. The package of claim 68, wherein the support is a blister pack.

73. A sleeve blank for use in a child-resistant slidable package comprising:
a plurality of integral sections demarcated by creases or scores, the sections comprising at least a minor side wall and a neighbouring major wall; and
at least one aperture straddling a crease or score between the side wall and the major wall, such that the aperture extends into the first side wall and into the major wall;
wherein the aperture is defined by one or more edges, at least one edge being disposed on the side wall and being non-linear so as to facilitate thumb or finger access to the aperture when the sleeve is folded.

74. A method of making a slidable package comprising;
arranging a band around a divider section of a sleeve blank;
bonding a support for packaged items to the band;
bonding the tab member of claim 1 to the band; and
folding the sleeve blank around the support and the tab member to assemble the band-driven package.
